(19) United States
(12) Patent Application Publication
(10) Pub. No.: US 2026/0264491 A1
(43) Pub. Date: Sep. 10, 2026

(54) TRUCK CAP SYSTEM FOR VEHICLE

(71) Applicant: WERNER CO., Itasca, IL (US)

(72) Inventors: Robert G. McRorie, III, Huntersville, NC (US); Juan Aviles Quintero, El Paso, TX (US); Derek E. Bibler, Charlotte, NC (US); Holly A. Coggins, Charlotte, NC (US); William J. Kozlowski, JR., Monroe, NC (US); Jeremy P. Hansen, Huntersville, NC (US); Adam B. Watson, Mooresville, NC (US); Thomas Lineberger, Charlotte, NC (US)

(21) Appl. No.: 19/555,166

(22) Filed: Mar. 3, 2026

Related U.S. Application Data
(60) Provisional application No. 63/766,529, filed on Mar. 4, 2025.

(51) Int. Cl. B60J 7/16

(52) U.S. Cl. CPC B60J 7/1607

(57) ABSTRACT

A truck cap system for a truck includes a frame configured to be removably coupled to the truck, a cover assembly removably coupled to the frame, and at least one of a storage module assembly or a side door assembly removably couplable to the frame. The frame has a pair of foundation rails configured to be removably coupled to the truck, a plurality of vertical posts extending from the plurality of foundation rails, and a pair of frame beams spaced from the foundation rails and coupled to the plurality of vertical posts. The cover assembly has a cover moveable between an open position and a closed position.

### CROSS-REFERENCE TO RELATED APPLICATIONS

This application claims priority to U.S. Provisional Patent Application No. 63/766,529, filed Mar. 4, 2025, the entire contents of which are hereby incorporated herein by reference.

### TECHNICAL FIELD

This disclosure relates generally to a truck cap system for a vehicle, and more particularly to a frame, an associated cover assembly mountable to a truck bed, and a slidable ladder rack mountable to the frame. Storage compartments may further be attachable to the frame.

### BACKGROUND OF THE INVENTION

Vehicles having open beds, such as trucks, for example, are popular for their versatility of use in personal, recreational, and business applications. Trucks are available in a wide variety of sizes, and have corresponding varying sized cabs and cargo beds.

Various accessories can be incorporated onto a truck bed, including tonneau covers, truck caps, and ladder racks. The size of the tonneau cover is heavily dependent on the truck geometry upon which it is intended to attach. Thus, to accommodate the range of trucks in the market, numerous versions of the tonneau cover are required to be manufactured. Additionally, it is difficult for a tonneau cover to co-exist with other desirable truck accessories, such as storage modules, ladder racks, transfer tanks, and the like. A tonneau cover can further be in the way of other items when deployed by blocking vertical space, or when retracted, as it can take up valuable truck bed space.

Side storage boxes for truck beds are typically mounted to the truck bed sides, wherein legs extending down from the storage box to the truck bed are fastened into place. Installers often struggle, however, to align the boxes to each other, and often the boxes are mis-aligned with respect to each other and are further not leveled; they lean forward or rearward.

### SUMMARY OF THE INVENTION

A first example is a frame system for attachment to a vehicle, comprising a pair of foundation rails for attachment to sidewalls of a truck bed, a plurality of vertical posts each having a first end and a second end, wherein the first end is affixed to one of the pair of foundation rails, and a pair of horizontal frame members, wherein the second end of each of the plurality of vertical posts is affixed to a horizontal frame member of the pair of horizontal frame members.

The frame system may further comprise a three panel retractable cover, comprising a first panel extending between and affixed to the pair of horizontal frame members, a second panel slidably attached to the first panel and extending between the pair of horizontal frame members, and a third panel rotatably and slidably attached to the second panel. In a closed position, the third panel is positioned vertically and is parallel to the plurality of vertical posts. In an opened position, the third panel is rotated so as to be positioned horizontally, and is slidable underneath the second panel. The second panel in turn is slidable underneath the first panel.

In some examples, the frame system comprises a multi-panel retractable cover. In some examples, the frame system has a four-panel retractable cover.

In some examples, the frame system has a roll-top cover.

In some embodiments, the frame system further comprises at least one side compartment having a door. The door is openable to provide access to a storage compartment or into the truck bed.

In some embodiments, a ladder rack may be affixed to the pair of horizontal frame members.

In some aspects, a truck cap system for a truck includes a frame configured to be removably coupled to the truck, a cover assembly removably coupled to the frame, and at least one of a storage module assembly or a side door assembly removably couplable to the frame. The frame has a pair of foundation rails configured to be removably coupled to the truck, a plurality of vertical posts extending from the plurality of foundation rails, and a pair of frame beams spaced from the foundation rails and coupled to the plurality of vertical posts. The cover assembly has a cover moveable between an open position and a closed position.

In some aspects, a truck cap system for a truck includes a frame configured to be coupled to the truck, an intermediate beam and a cover assembly. The frame includes a plurality of posts, and a frame beam coupled to the plurality of posts. The frame beam defines one of a recess or a ridge. The intermediate beam is removably coupled to the frame beam of the frame. The intermediate beam includes a support portion, and an interlocking portion defining the other of the recess or the ridge. The ridge is received in the recess to interlock the frame beam and the intermediate beam. The cover assembly is removably coupled to the support portion of the intermediate beam such that the cover assembly is removably mounted on the frame via the intermediate beam.

In some aspects, a truck cap system for a truck includes a frame configured to be coupled to the truck, and a slidable ladder rack assembly removably coupled to the frame. The frame includes a plurality of posts, and a pair of frame beams coupled to the plurality of posts. The slidable ladder rack assembly includes a pair of track members each corresponding to and removably mounted on a respective one of the frame beams, and a rack slidably supported on the pair of track members.

By the term “about” or “substantially”, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The features, functions, and advantages that have been discussed can be achieved independently in various examples or may be combined in yet other examples; further details of which can be seen with reference to the following description and drawings.

### BRIEF DESCRIPTION OF THE DRAWINGS

The above, as well as additional, features, will be better understood through the following illustrative and non-limiting detailed description of example embodiments, with reference to the appended drawings.

FIG. 1a is a perspective view of a truck cap system, according to an example.

FIG. 1b is a perspective view of a three panel cover of the truck cap system of FIG. 1a, according to an example.

FIG. 2 is a perspective view of the truck cap system of FIG. 1a with the panels in a retracted position to provide vertical access to the truck bed, and a side compartment door open to provide side access to the truck bed, according to an example.

FIG. 3 is a perspective view of a truck, such as the truck of FIG. 1a, with foundation rails installed on the truck bed sidewalls, according to an example.

FIG. 3a shows a detailed view of an attachment system for affixing a foundation rail, such as the foundation rails of FIG. 3, on the truck bed sidewalls, according to an example.

FIG. 4 is a perspective view of the truck of FIG. 3 with a frame mounted on the foundation rails, according to an example.

FIG. 5a illustrates a sliding ladder rack mounted to the frame of FIG. 4, according to an example.

FIG. 5b illustrates a fixed ladder rack mounted to the frame of FIG. 4, according to an example.

FIG. 5c illustrates a fixed full length ladder rack mounted to the frame of FIG. 4, according to an example.

FIG. 5d illustrates a detailed view of a portion of the sliding ladder rack of FIG. 5a, according to an example.

FIG. 5e illustrates another detailed view of a portion of the sliding ladder rack of FIG. 5a, according to an example.

FIG. 6a is a perspective view showing an opened storage module for use with the truck cap system of FIG. 1a, according to an example.

FIG. 6b is a perspective view showing an opened storage module door for use with the truck cap system of FIG. 1a, the opened door providing access into the truck bed, according to an example.

FIG. 7a shows a second example of a four panel cover to be used with the truck cap system of FIG. 1a.

FIG. 7b shows a third example of a cover assembly to be used with the truck cap system of FIG. 1a.

FIG. 8a shows a detailed view of weatherproofing for a storage module, such as the storage module of FIGS. 6a-b, to prevent fluid from flowing into the storage module.

FIG. 8b shows a detailed view of weatherproofing seals on top panels of a truck cap system, such as the truck cap system of FIG. 1a.

FIG. 8c shows a detailed view of tracks to receive one or more top panels of FIG. 8b.

FIG. 8d shows a rear panel comprising holes for fluid exit.

FIG. 8e shows a detailed perspective view of the frame of FIG. 4.

FIG. 9 shows a top perspective view of a truck cap system, according to an example, with a cover in a closed position and with a slidable ladder rack in an extended position.

FIG. 10 shows a bottom perspective view of the truck cap system of FIG. 9, with the cover in the closed position and with the slidable ladder rack in the retracted position.

FIG. 11 shows a top perspective view of the truck cap system of FIG. 9, with the cover in the open position and with the slidable ladder rack in the retracted position.

FIG. 12 shows an exploded view of the truck cap system of FIG. 9.

FIG. 13 shows a top perspective view of a frame of the truck cap system of FIG. 9.

FIG. 14a shows a bottom perspective view of the frame of the truck cap system of FIG. 9.

FIG. 14b shows a partially exploded bottom view of the frame of FIG. 13 with a seal.

FIG. 15 shows an exploded view of a foundation rail and a clamping bracket of the frame of FIG. 13.

FIG. 16a shows a detailed exploded view of the foundation rail and a vertical post of the frame of FIG. 13.

FIG. 16b shows an enlarged bottom view of the foundation rail and the vertical post of the frame of FIG. 13.

FIG. 17 shows an exploded view of the vertical post and a horizontal beam of the frame of FIG. 13.

FIG. 18 shows a perspective view of a portion of a horizontal beam and a portion of a cross-bar of the frame of FIG. 13.

FIG. 19 shows an enlarged perspective view of the truck cap system of FIG. 9 with a storage module assembly having a door panel in an open position.

FIG. 20a shows an enlarged perspective view of the storage module assembly of FIG. 19 with a door panel removed.

FIG. 20b shows a cross-section view of the top of the storage module assembly of FIG. 19 and the frame of the truck cap system of FIG. 9.

FIG. 20c shows another cross-section view of a side of the storage module assembly of FIG. 19 and the frame of the truck cap system of FIG. 9.

FIG. 20d shows another cross-section view of the bottom of the storage module assembly of FIG. 19 and the frame of the truck cap of FIG. 9.

FIG. 21a shows a cross-section view of the storage compartment, the frame, and a seal of the truck cap system of FIG. 9.

FIG. 21b shows a cross-section view of the storage compartment, the frame, and another seal of the truck cap of FIG. 9.

FIG. 22 shows a perspective view of a locking mechanism of the storage compartment of the truck cap system of FIG. 9.

FIG. 23 shows a perspective view of a locking assembly of the locking mechanism of FIG. 22.

FIG. 24 shows a perspective view of a latching assembly of the locking mechanism of FIG. 22.

FIG. 25 shows a cross-section view of the latching assembly of FIG. 24.

FIG. 26 shows a perspective view of another example of a latching assembly of the locking mechanism of FIG. 22.

FIG. 27 shows an enlarged perspective view of the truck cap system of FIG. 9 with a side door assembly with a door panel in an open position.

FIG. 28 shows a detailed perspective view of the slidable ladder rack of the truck cap system of FIG. 9.

FIG. 29 shows a detailed perspective view of a rack portion of the slidable ladder rack of the truck cap system of FIG. 9.

FIG. 30 shows a cross-section view of the slidable ladder rack of the truck cap system of FIG. 9.

FIG. 31 shows an enlarged perspective view of the slidable ladder rack of the truck cap system of FIG. 9.

FIG. 32 shows an enlarged perspective view of a locking mechanism of the slidable ladder rack of the truck cap system of FIG. 9.

FIG. 33 shows a perspective view of a locking assembly of the locking mechanism of FIG. 32.

FIG. 34 shows a perspective view of another example of a locking mechanism of the slidable ladder rack of the truck cap system of FIG. 9.

FIG. 35 shows a cross-section view of a horizontal beam and the slidable ladder rack of the truck cap system of FIG. 9.

FIG. 36 shows a cross-section view of a horizontal beam and an intermediate beam of the truck cap system of FIG. 9.

FIG. 37 shows a perspective view of the intermediate beam of the truck cap system of FIG. 9.

FIG. 38a shows a perspective view of a cover assembly of the truck cap system of FIG. 9 with a cover in an intermediate position.

FIG. 38b shows a cross-section view of the cover assembly of FIG. 38a.

FIG. 38c shows an enlarged perspective view of the cover assembly of FIG. 38a.

FIG. 38d shows a cross-section view of the truck cap system of FIG. 9.

FIG. 38e shows an enlarged cross-section view of the cover assembly and an intermediate post of the truck cap system of FIG. 9.

FIG. 39a shows another cross-section view of the cover assembly of FIG. 38a.

FIG. 39b shows a perspective view of a roller of the cover assembly of FIG. 38a.

FIG. 39c shows a perspective view of components of the roller of the cover assembly of FIG. 38a with the body of the roller removed.

FIG. 39d shows a cross-section view of an example of a motor assembly to be used with the cover assembly of FIG. 38a.

FIG. 39e shows a cross-section view of another example of a motor assembly to be used with the cover assembly of FIG. 38a.

FIG. 40 shows a perspective view of a locking mechanism of the cover assembly of FIG. 38a.

FIG. 41 shows a perspective view of a locking assembly of the locking mechanism of FIG. 40.

FIG. 42 shows a perspective view of a latching assembly of the locking mechanism of FIG. 40.

FIG. 43a shows an enlarged perspective view of the truck cap of FIG. 9 with rear frame caps removed.

FIG. 43b shows a perspective view of another example of a latching assembly of the locking mechanism of FIG. 40.

FIG. 44 shows a perspective view of a stopping mechanism of the cover assembly of FIG. 38a.

FIG. 45 shows a perspective view of a front wall of the truck cap system of FIG. 9.

FIG. 46 shows a cross-section view of the front wall and a top panel of the truck cap of FIG. 9.

FIG. 47 shows a perspective view of the vertical post and the front wall of the truck cap system of FIG. 9.

### DETAILED DESCRIPTION

A frame that mounts onto truck bed sides is described herein, to establish a plane for a truck cap system having a retractable, slidable cover and storage modules, as well as a retractable or sliding ladder rack. The retractability of the cover of the truck cap system provides vertical space for transporting taller items, as well as to help load a ladder rack from the truck bed. The storage module assemblies may provide compartments for storage of items, and the side door assemblies may serve as an additional, side pass-through to the truck bed.

Disclosed examples will now be described more fully hereinafter with reference to the accompanying Drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

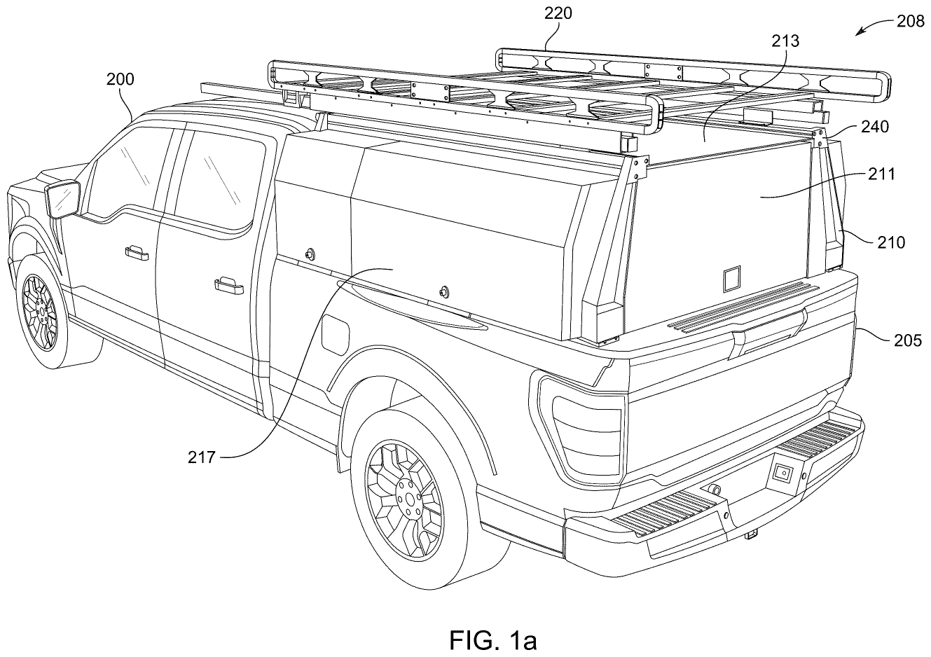

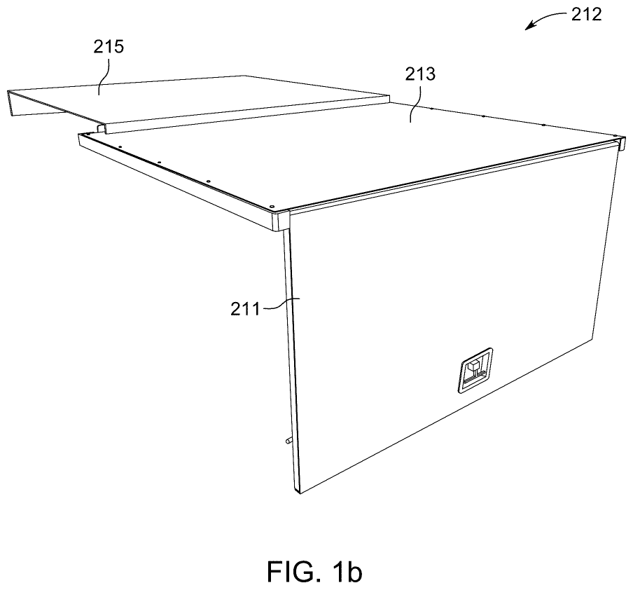

FIG. 1a is a perspective view of a truck cap system 208 having a frame 240, a cover assembly 210 supported by the frame 240, a plurality of side compartment doors 217 supported by the frame 240, and a slidable ladder rack 220 supported by the frame 240, according to an example embodiment. The frame 240 is shown mounted to a truck bed 205 of a truck 200. The frame 240 and the cover assembly 210 may be designed to fit various pickup truck bed arrangements. For example, the frame 240 and the cover assembly 210 may fit pickup truck beds having various sizes.

The cover assembly 210 comprises a rear panel 211 and a sliding top panel 213. In FIG. 1a, the rear panel 211 and the sliding top panel 213 are shown in an extended, closed position so as to form a roof and backwall of the truck cap system 208, closing off access to an interior of the truck bed. Also shown in FIG. 1a are a plurality of side compartment doors 217, each supported by the frame and in a closed position.

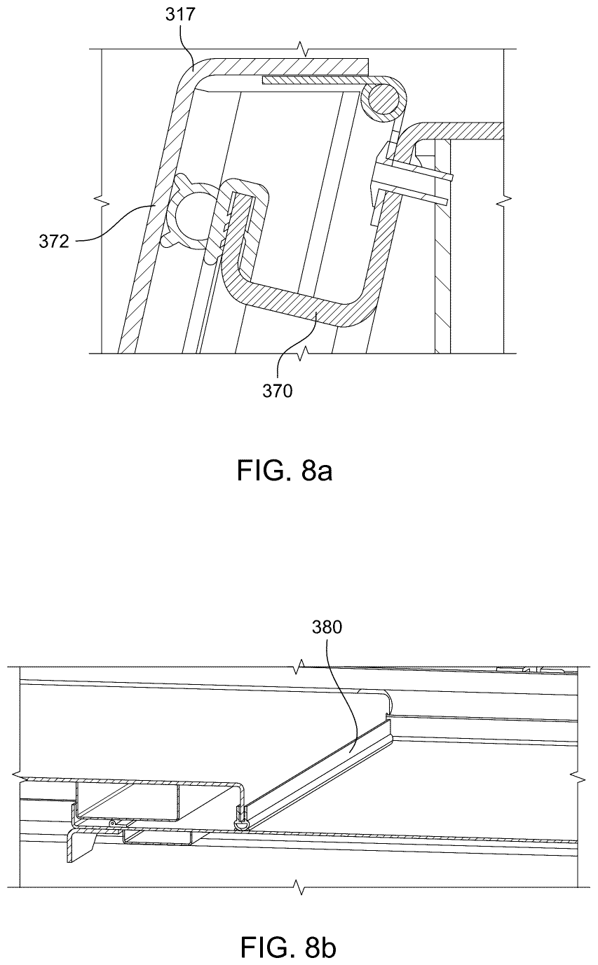

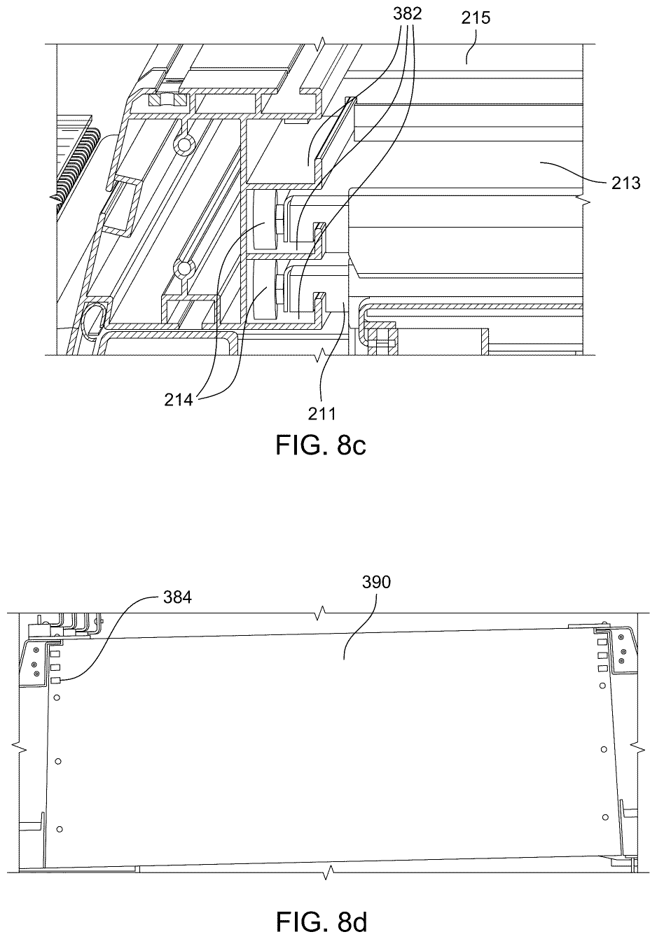

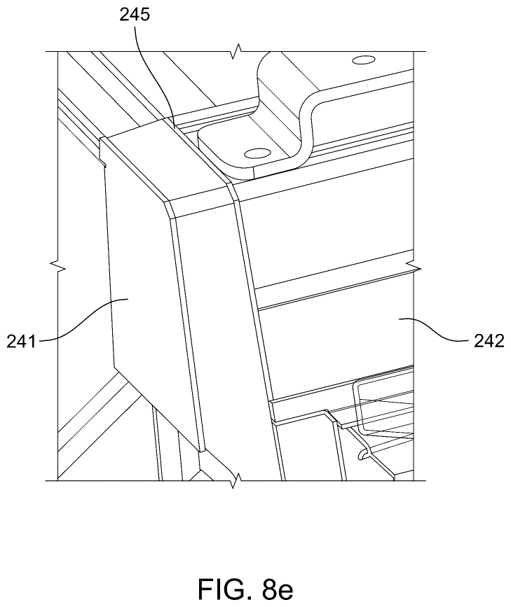

FIG. 1b is a perspective view of a three panel cover 212 of the cover assembly 210 of FIG. 1a, according to an example. In this embodiment, the three panel cover 212 comprises the rear panel 211, the sliding top panel 213, and a fixed top panel 215. The rear panel 211 and the sliding top panel 213 are moveable. In operation, the rear panel 211 may be rotated about a pivot via one or more piston assemblies, from a vertical position resting above the tailgate (shown in FIG. 1b) to a horizontal position, and may then proceed to slide under the sliding top panel 213 until the rear panel 211 is substantially underneath the sliding top panel 213. The panels 211, 213 may slide via wheels, or rollers 214, contained within tracks 382 within the panel frames (FIG. 8c). In some examples, the panels 211, 213 may slide via low-friction end caps or slide plates contained within the tracks 382. The rear panel 211 continues to slide under the sliding top panel 213 until it is positioned substantially underneath the sliding top panel 213, at which point a flange extending from the top surface of the rear panel 211 will abut and then push against an extrusion extending from the bottom surface of the sliding top panel 213. Both panels then proceed to move together toward the fixed top panel 215.

To initiate opening the rear panel 211, a user may push a push button on the rear panel, whereupon one or more pistons are then activated to pivot and swing open the rear panel 211, maintaining the rear panel in its open position until a user activates (e.g., grabbing and pulling on a manual pull strap) the rear panel 211 to close the panel, preventing an inadvertent collapse back to the closed position and injuring the user. The rear panel 211, once swung open, may then proceed to slide underneath the sliding top panel as described above, moving in the direction toward the truck bulkhead and sliding underneath the fixed top panel 215, until the combined sliding top panel 213 and the rear panel 211 rest substantially under the fixed top panel 215. The sliding top panel 213 may itself have a flange extending from its top surface to abut against an extrusion extending from the bottom of the fixed top panel 215.

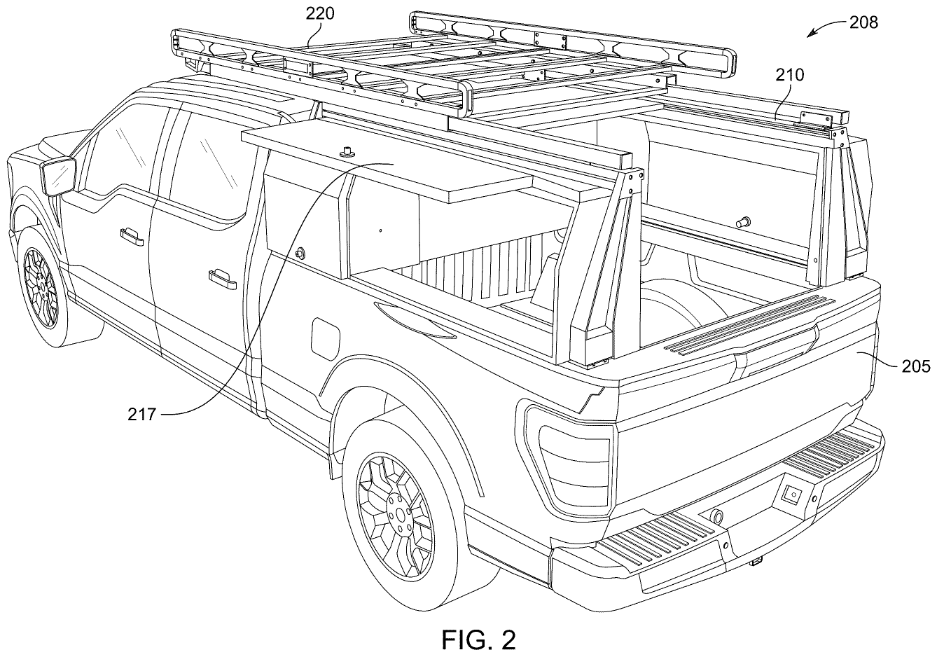

The fully retracted position is shown in FIG. 2 and exposes and provides vertical access to the truck bed 205. The sliding and fixed top panels 213, 215 may be positioned at the same or substantially the same height as the truck cab roof height, allowing for a much larger volume of space that is protected from weather and theft within the truck bed.

FIG. 2 additionally shows an example for the truck cap system 208 that allows for side access into the truck bed 205, wherein one of the plurality of side compartment doors 217 is opened and serves as a pass-through into the truck bed 205. In some examples, a portion of the bottom framework of the side compartment door 217 may be cut out to allow for increased space in the interior.

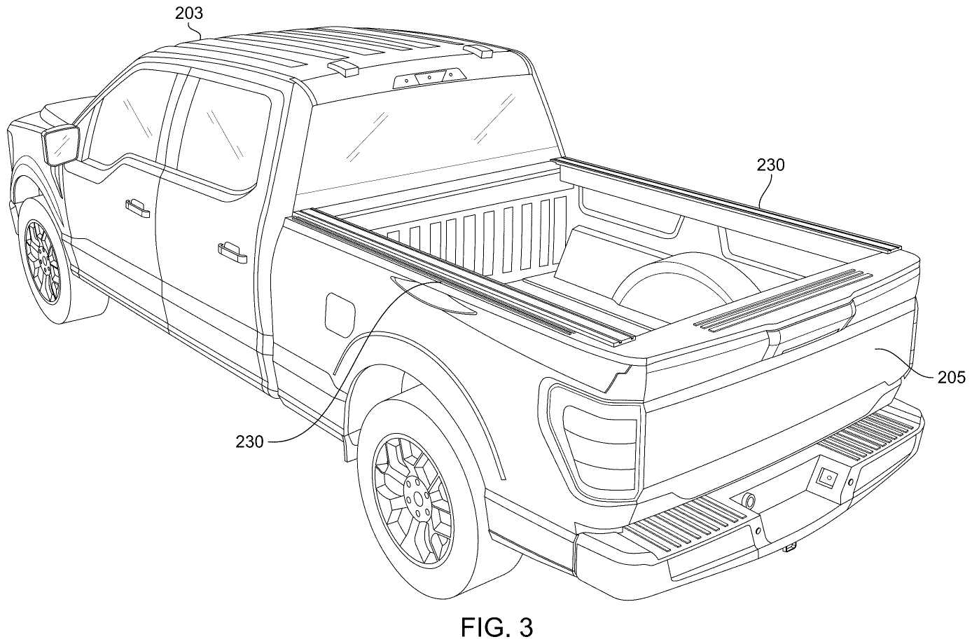

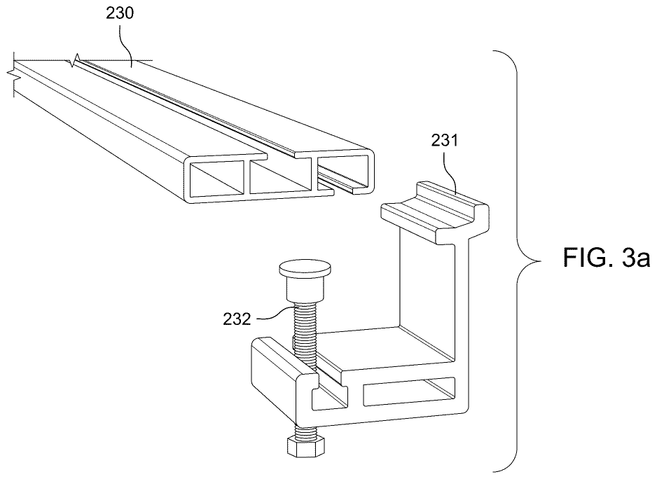

FIG. 3 is a perspective view of the truck, such as the truck 200 of FIG. 1a, with foundation rails 230 installed on the truck bed sides, according to an example. Each of the pair of foundation rails 230 affixes to a side wall of the truck bed 205. Clamping brackets 231, shown in FIG. 3a, on either truck bed side (e.g., three or four clamps per side) may be affixed to the truck bed side, and may each comprise a bolt 232 threaded into the clamping bracket. The bolt 232 may be tightened to sandwich the top surface rail of the truck bed side between the foundation rail 230 and the bolt 232.

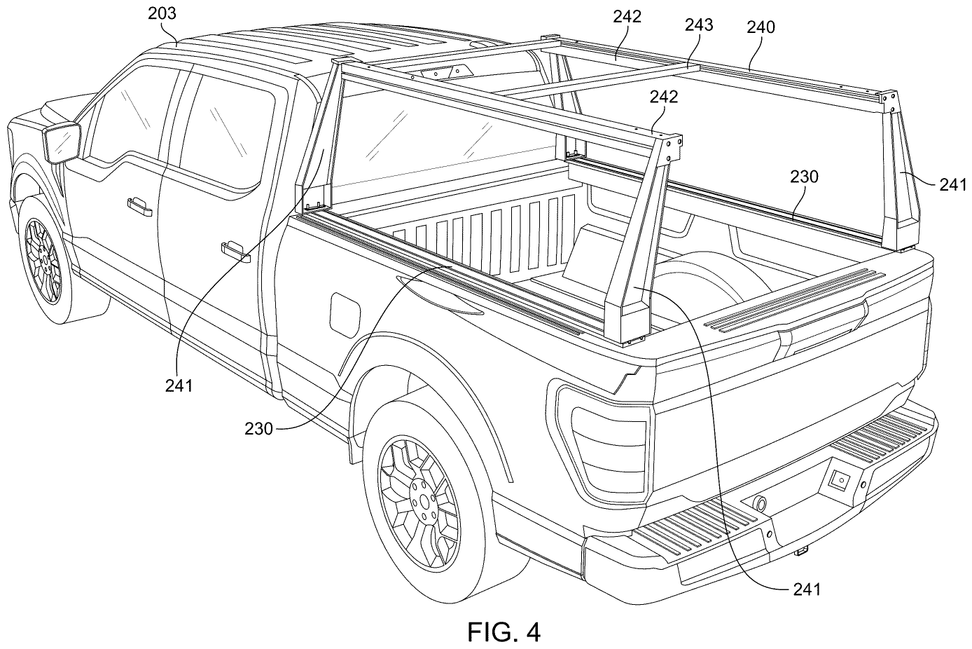

FIG. 4 is a perspective view of the truck of FIG. 3 with the frame 240 mounted to the foundation rails 230, according to an example. The frame 240 comprises four vertical posts 241, each affixed at a first end to one of the pair of foundation rails 230, and each affixed at a second end to two horizontal beams 242 running substantially parallel to the pair of foundation rails 230. The first ends of each of the vertical posts 241 may be fastened into place onto the foundation rails 230 using a variety of fastening mechanisms, such as via bolts that extend through corresponding holes in both the first end of the vertical post 241 and the foundation rail 230. Cover plates may be affixed to the vertical posts 241 to cover the bolts.

The frame system 240 components may be pre-assembled prior to installation onto the truck bed, or may be assembled and bolted piece by piece to the foundation rails 230 after the foundation rails 230 are affixed to the truck bed sides. Further, the truck cap system 208, including the frame 240, the cover assembly 210, the side compartment doors 217, and the slidable ladder rack 220, may be pre-assembled prior to installation onto the truck bed, or may be assembled and bolted piece by piece to the foundation rails 230 after the foundation rails 230 are affixed to the truck bed sides.

Additional frame beams 243 may extend between the two horizontal beams 242 to further strengthen the frame structure and prevent the two horizontal beams 242 from swaying during vehicle movement and during use of the frame 240.

With respect to FIG. 8c, the fixed panel 215 may be installed first and via bolts to the frame 240. After the fixed top panel 215 is installed, the rear panel 211 may be slid into a lower track 382 on the horizontal beams 242, and one or more sliding top panels 213 may then slide into additional tracks 382 above the lower track 382 on the horizontal beams 242. After the panels 211, 213 are installed, end caps may be affixed to the horizontal beams 242 to keep the sliding panels from pulling out of the top frame rail tracks 382 and to provide a sealing surface against the rear panel 211.

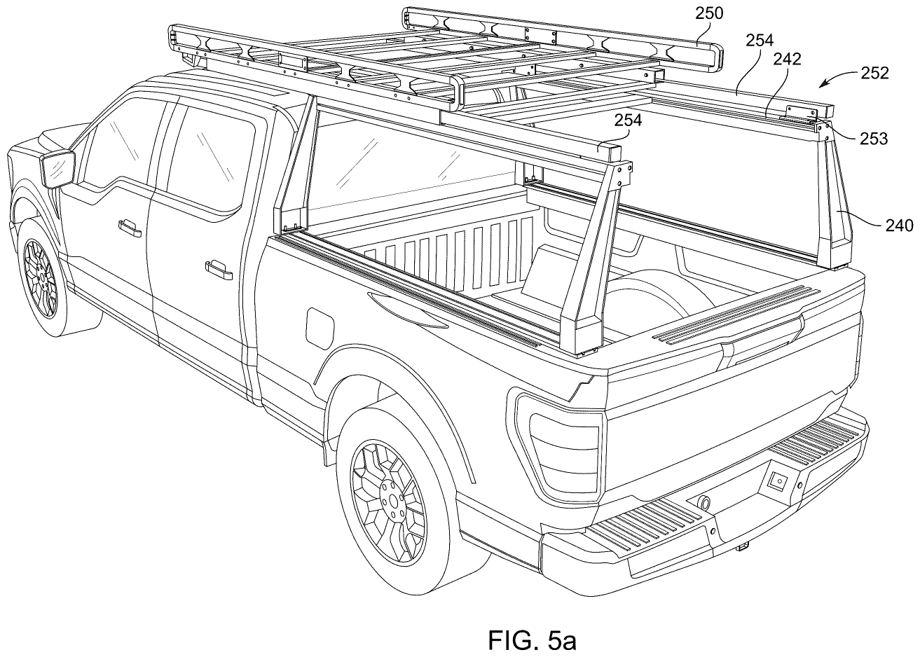

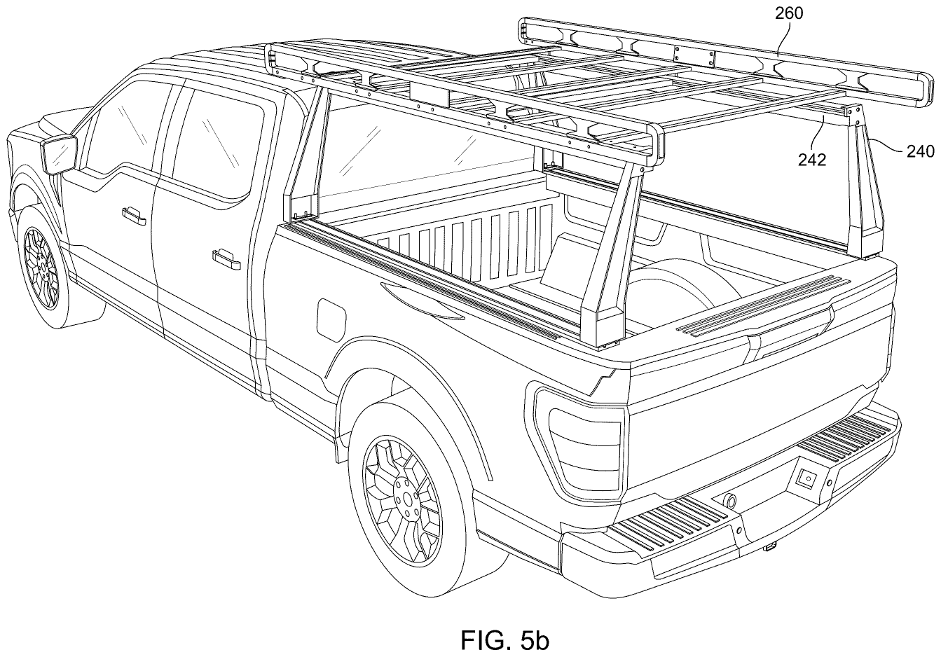

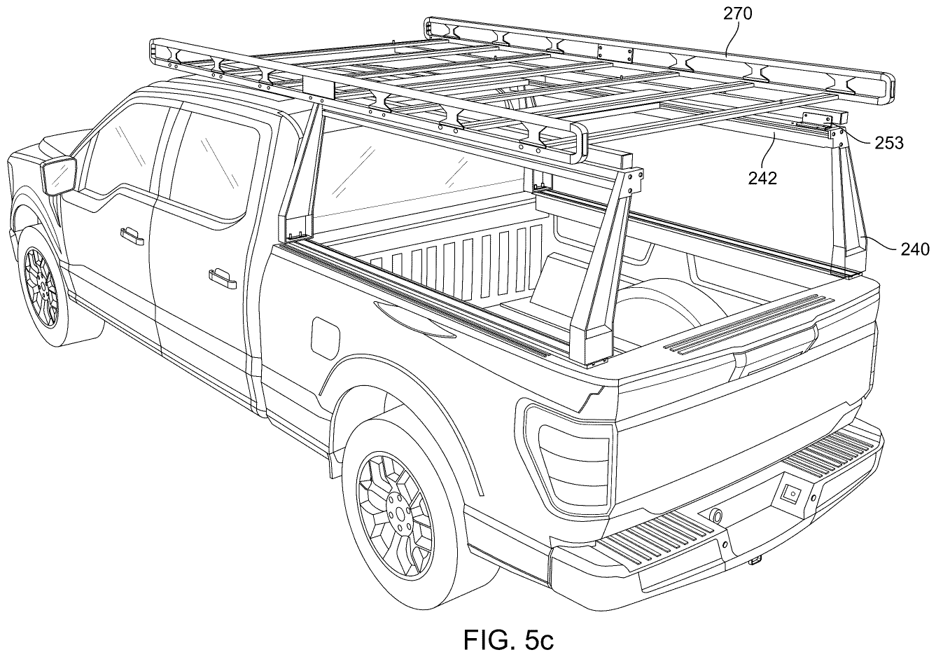

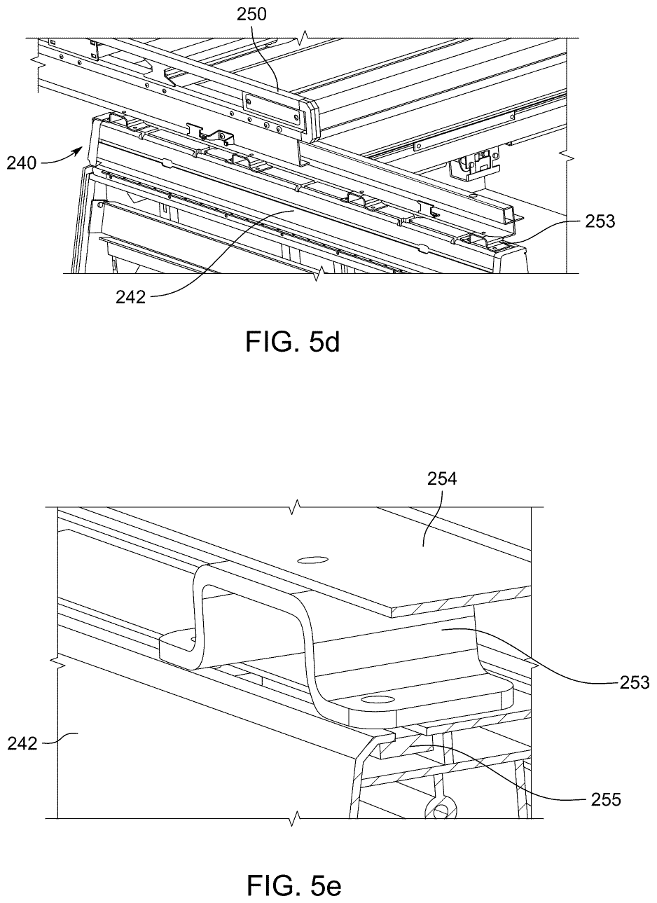

FIG. 5a illustrates a sliding ladder rack 250 mounted to the frame 240 of FIG. 4, according to an example. As shown in FIG. 5a, the sliding ladder rack 250 is mounted to the two horizontal beams 242 via a rack frame 252 including a pair of track members 254. Each of the pair of track members 254 is coupled to a respective horizontal beam 242 via brackets 253, as will be discussed in greater detail below. A slidable ladder rack 250 is beneficial as a truck's needs and usage can vary frequently, and sometimes a tall item needs to be carried in the truck bed, and the ladder rack 250 is in the way of the vertical space required. By sliding the ladder rack 250 in the direction toward the bulkhead, the vertical space is freed up. Accordingly, the ladder rack 250 may be moved to and locked relative to the frame 240 to maintain the ladder rack 250 in different positions. Additionally, the ability to slide the ladder rack 250 provides for easier installation of the ladder rack 250 onto the frame 240, as a user can stand on the truck bed to install the ladder rack 250 in the forward position, before sliding the installed ladder rack backwards.

As illustrated in FIGS. 5d and 5e, to mount the sliding ladder rack 250 to the frame 240, anchor bars 255 are slid into rails of each of the horizontal beams 242. Bolts are then fed through brackets 253 and threaded into the anchor bars 255 to sandwich the horizontal beam 242 between the anchor bars 255 and the brackets 253. In some examples, the heads of the bolts may be slid into rails of each of the horizontal beams 242, and the anchor bars 255 may be threaded onto the bolts. Then, each track member 254 is set on top of the brackets 253 and coupled thereto. The ladder rack 250 is then slidably coupled to the track members 254. The ladder rack 250 may be locked relative to the track members 254 to maintain the ladder rack 250 in different positions.

FIG. 5b illustrates a fixed ladder rack 260 mounted to a frame such as the frame 240 of FIG. 4, according to an example. As shown in FIG. 5b, the fixed ladder rack 260 is mounted to the two horizontal beams 242. The fixed ladder rack 260 can be mounted to the horizontal beams 242 via brackets 253. In other examples, the brackets 253 may be different shapes, such as the shape of the brackets discussed below.

FIG. 5c illustrates a fixed full length ladder rack 270 mounted to a frame such as the frame 240 of FIG. 4, according to an example. As shown in FIG. 5c, the fixed full length ladder rack is mounted to the two horizontal beams 242. The fixed full length ladder rack 270 may be mounted to the horizontal beams 242 via brackets 253. In other examples, the brackets 253 may be different shapes, such as the shape of the brackets discussed below. The fixed full length ladder rack accommodates longer items, such as longer versions of extension or step ladders.

A release lever and latch mechanism may be accessible from the inside of the cab of the truck to release the ladder rack from its attachment to the cab frame.

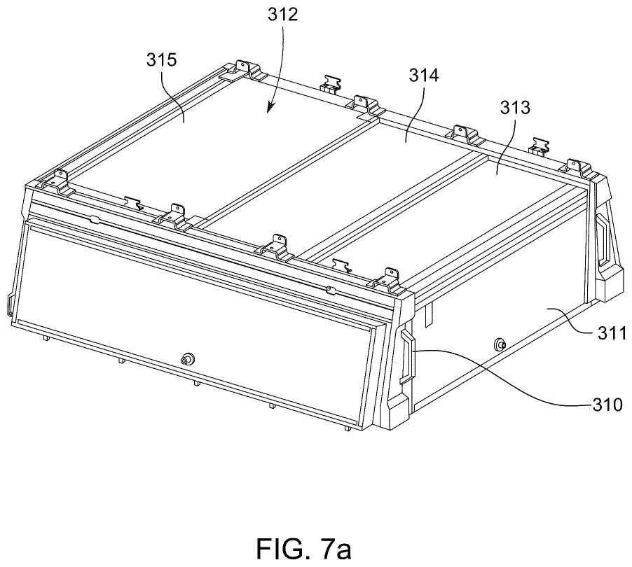

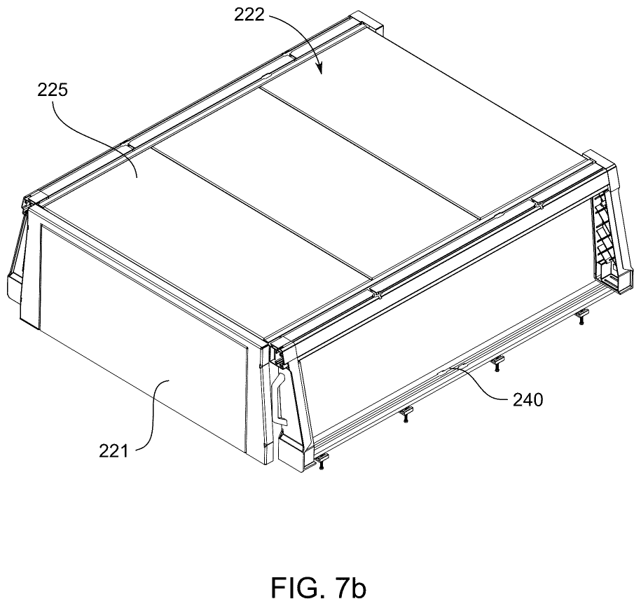

In some examples, the frame 240 may further comprise integrally formed handles 310 (FIG. 7a) to allow a user to grab onto to climb up the frame 240 and access the top of the cover assembly 210, or the ladder rack. The ladder rack may additionally have one or more handles as well.

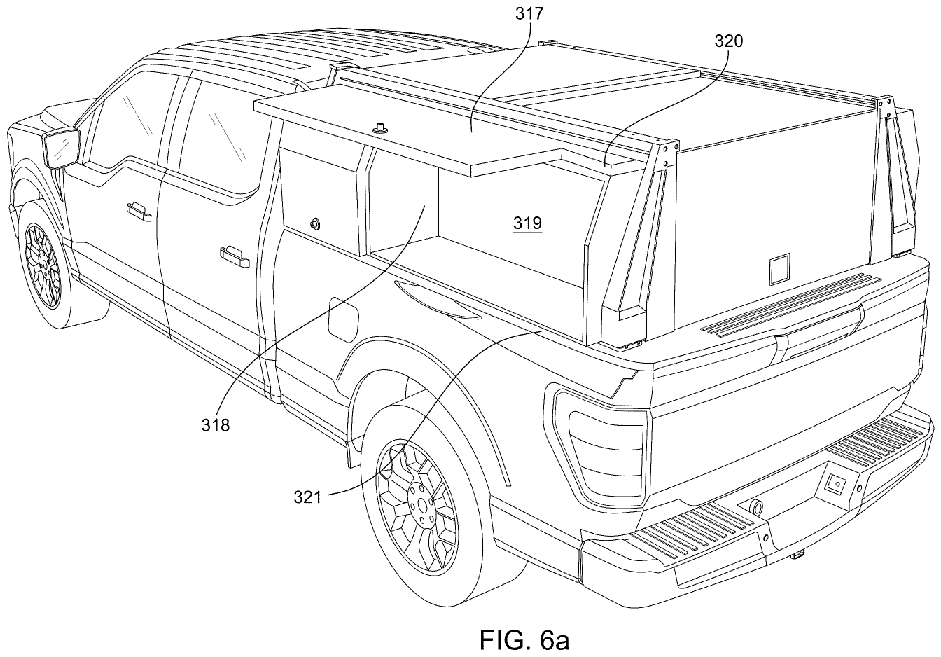

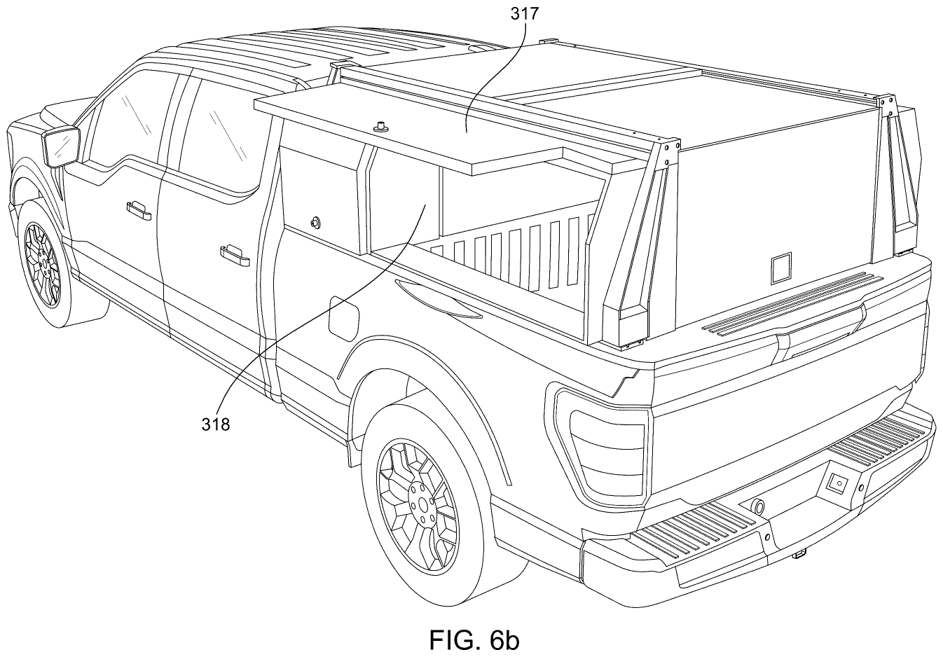

FIG. 6a is a perspective view showing an opened storage module 318 of the truck cap system 208, according to an example. In the embodiment shown in FIG. 6a, a door 317 (similar to the doors 217 discussed above) of one of a plurality of sidewall storage modules 318 is opened, allowing for side access into the compartment. The compartment in FIG. 6a has a rear wall 319 forming an interior space of the compartment, and not allowing for access into the truck bed. In some embodiments, the compartment may additionally comprise shelves. The plurality of sidewall storage modules 318 may be connected to and part of a side compartment framework 320 that is attachable to the foundation rails 321 of the frame system.

FIG. 6b is a perspective view showing a storage module 318 of the truck cap system 208 with the opened door 317 providing access into the truck bed, as the storage module 318 does not have a rear wall to form a separate compartment. Instead, the opened door 317 provides access into the truck bed, serving as a pass-through into the truck bed.

The storage modules 318 may be affixed to the frame via anchor bars that are slid into the frame rail tracks, and bolts are then threaded into the anchor bars; the anchor bars and bolts may be used to affix the storage modules 318 to both an upper frame piece and the foundation rail 321 of the frame structure. In some examples, bolts may affix the storage modules 318 to the vertical posts 241 of the frame 240.

FIG. 7a shows a second embodiment of a four panel cover 312 to be used with the truck cap system 208, such as the truck cap system 208 of FIG. 1a, according to an example. In this embodiment, the four panel cover 312 comprises a rear panel 311, a first sliding top panel 313, and a second sliding top panel 314, and a fixed top panel 315. In operation, the rear panel 311 may be rotated about a pivot from a vertical position resting above the tailgate to a horizontal position, and may then slide under the first sliding top panel 313 until the rear panel 311 is substantially underneath the first sliding top panel 313. The first sliding top panel 313 and rear panel 311 then proceed to move together in the direction of the truck bulkhead, sliding underneath the second sliding top panel 314. The combined first and second sliding top panels 313, 314, and rear panel 311 then further move in the direction toward the truck bulkhead, sliding underneath the fixed top panel 315, until the combined first and second sliding top panels 313, 314, and the rear panel 311 rest substantially under the fixed top panel 315.

FIG. 7b illustrates another example of a cover 222 to be used with the truck cap system 208, such as the truck cap system 208 of FIG. 1a. The cover 222 may be primarily fixed with a pivotable or moveable rear panel 221 such that the cover 222 is movable relative to the frame 240 between a closed position and an open position. For example, the cover 222 may include only a fixed top panel 225 coupled to the frame 240 and a rear panel 221.

To prevent damage to property stored within the truck cab, it is important to keep fluids, such as rain, sleet, or snow, for example, from leaking into the truck cab interior. To this end, various weatherproofing materials, structures, and assemblies may be formed onto the cover assembly 210.

In some example embodiments, gaskets and seals may be placed on the bottom surface of the foundational rails 230 to seal the interface between the truck bed sides and the frame 240, preventing fluid ingress under the frame 240. Further, gaskets and seals may be placed at frame-to-frame interfaces. For example, as shown in FIG. 8e, a seal 245 may be positioned between each end of each horizontal beam 242 and each respective post 241. When the frame pieces are bolted together, the seals 245 are then compressed to prevent leakage therebetween. In some embodiments, the seals may be rubber or foam, although any suitable material may be used. In some examples, the seals may comprise rubber, and the foundation rails 230, the posts 241, and horizontal beams 242 may be powder coated aluminum, which respectively sandwich the rubber seals. In other examples, the seals may comprise rubber, and the foundation rails 230, the posts 241, and horizontal beams 242 may comprise powder coated aluminum and painted steel, which respectively sandwich rubber seals. Rubber seals additionally may run along the tracks of the frame pieces, and along the top surface and side edge surfaces of the storage module 318.

To weatherproof the door-to-body interface of the storage module, as shown in FIG. 8a, a gutter-shaped lip 370 on a storage module, such as the storage module 318 of FIGS. 6a-b, may be formed along the edges of the body of the module to prevent fluid from flowing into the storage module. Rubber seals 372 may additionally be placed along the sides, sandwiched between the door and the module body. The door latch would further compress the seals to prevent fluid leakage.

Rubber seals 380 may additionally be formed along the perimeter of each of the fixed and sliding top panels to prevent fluid from flowing in-between the panels, as shown in a detailed view in FIG. 8b. The fluid may be directed out either the front or the rear of the truck cap system, or into the tracks 382 for the wheels 214 of the panels, wherein the tracks 382 also serve as gutters, as shown in the detailed view of FIG. 8c. The tracks 382 would be in fluid communication with holes 384 extending through end panels, as shown in FIG. 8d, to allow for any fluid that flows through the tracks to drain out the system through the holes 384. The front panel 390 of the elevated cover system may additionally have rubber seals along its perimeter.

FIGS. 9-12 illustrate a truck cap system 400 according to another example of the invention. The truck cap system 400 is similar to the truck cap system 208 discussed above. The truck cap system 400 has a frame 404 configured to be mounted to a bed of a truck. The frame 404 is selectively removable from the truck. The truck cap system 400 is modular, like the cover assembly 210, and may selectively include one or more optional components, such as a cover assembly 408, a storage module assembly 416, a side door assembly 420, and a ladder rack assembly 412. Any of the optional components may be included alone or in any combination, and each optional component may be provided in a single instance or multiple instances. For example, the truck cap system 400 may include two storage module assemblies 416, two side door assemblies 420, or one storage module assembly 416 and one side door assembly 420. In the illustrated example, the sliding ladder rack assembly 412 is selectively mounted on the frame 404. In some examples, the truck cap system 400 may include a fixed ladder rack selectively mounted to the frame 404, a storage module assembly 416, and a side door assembly 420.

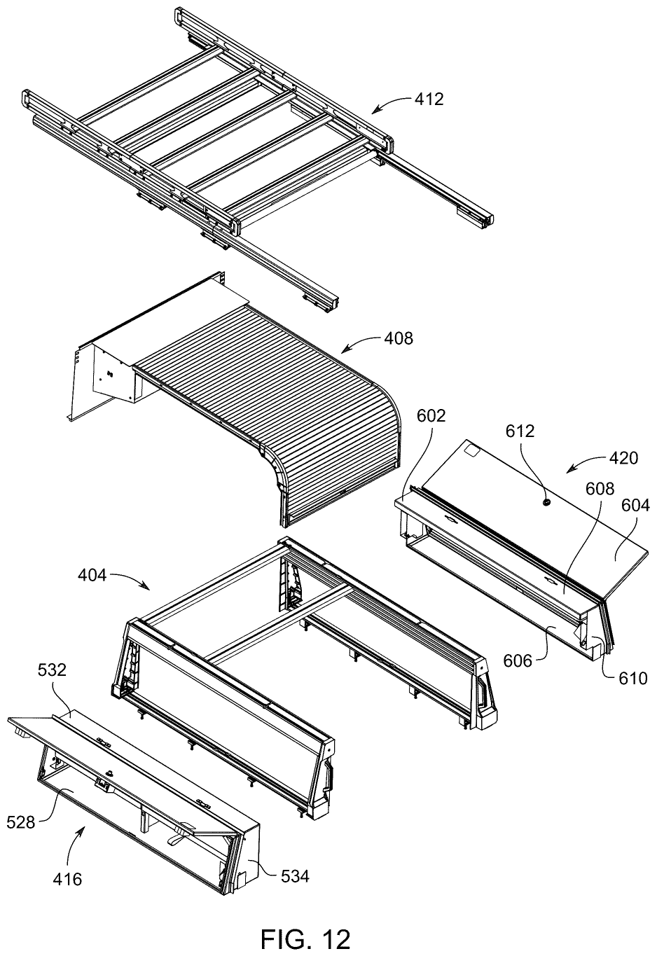

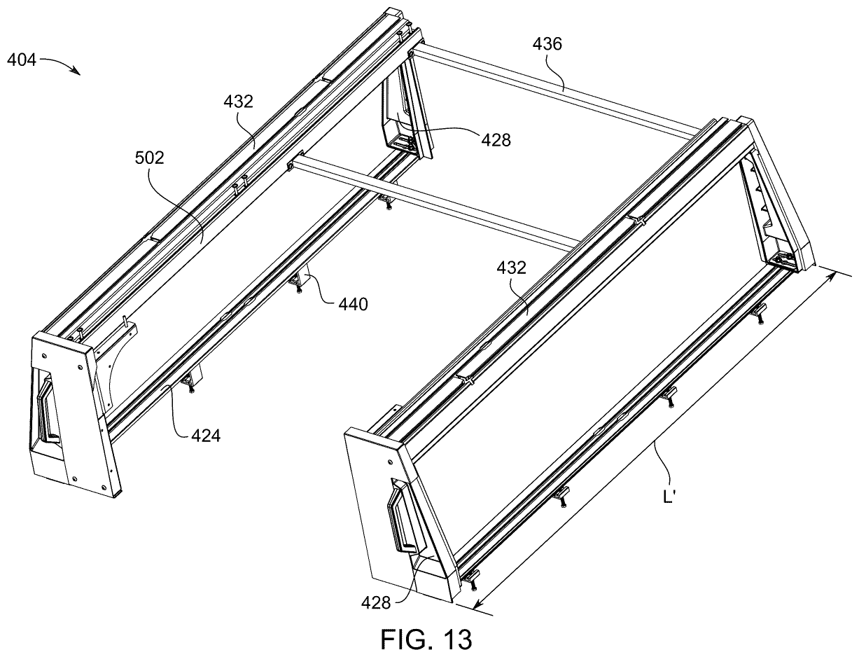

The frame 404 includes a front end 421 configured to be positioned adjacent a cab of the truck and a rear end 422 opposite the front end 421. The frame 404 further includes a bottom end 423 configured to be coupled to the truck bed and a top end 425 opposite the bottom end 423. The truck cap system 400 has a longitudinal direction L. The front end 421 and the rear end 422 are spaced apart along the longitudinal direction L and define a length L′ (FIG. 13).

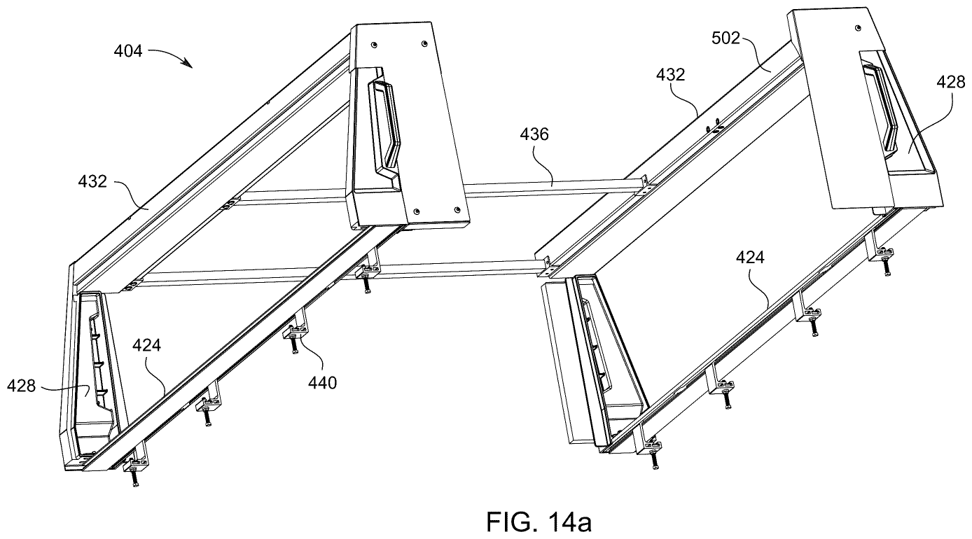

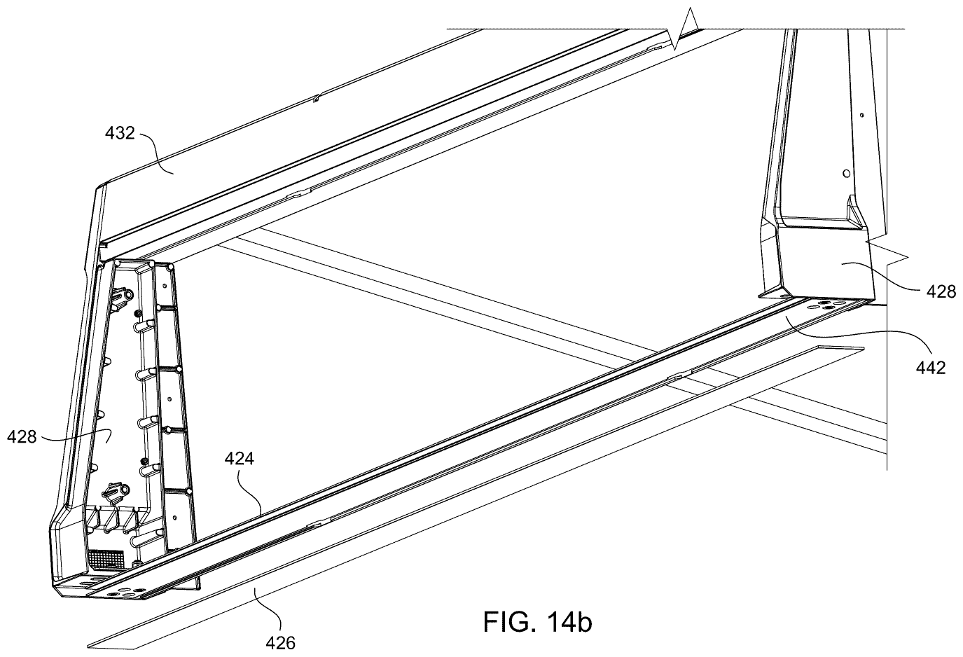

As illustrated in FIGS. 13 and 14a-b, the frame 404 includes a pair of foundation rails 424 configured to be coupled to the truck. The frame 404 further includes a plurality of posts 428 coupled to the foundation rails 424. The posts 428 are vertical posts. In the illustrated example, each vertical post 428 is positioned at a respective end of one of the foundation rails 424. The frame 404 includes a pair of horizontal beams 432, or frame beams, coupled to and supported by the plurality of posts 428. The horizontal beams 432 run parallel to the foundation rails 424. The horizontal beams 432 are vertically spaced from the foundation rails 424. The frame 404 further includes cross-bars 436 extending between the horizontal beams 432. The cross-bars 436 extend perpendicular to the horizontal beams 432 and the foundation rails 424. The cross-bars 436 provide support to the structure of the frame 404 to prevent swaying. The cross-bars 436 are positioned such that tall items, such as pallets, may be placed into the truck bed without removing the frame 404. That is, as shown, the cross-bars 436 are both positioned closer to the front end 421 than the rear end 422. In particular, the cross-bars 436 are only positioned along a third of the length L′ as measured from the front end 421. In other embodiments, the cross-bars 436 may be positioned along a quarter of the length L′ or a half of the length L′ as measured from the front end 421. The frame 404 defines a central point along the length L′ that is half-way between the front end 421 and the rear end 422. The frame 404 is devoid of a cross-bar in a region measured between the rear end 422 and the central point. In other embodiments, the central point may be one third of the distance from the front end 421 or three-fourth of the distance from the front end 421 as measured along the length L'. The cross-bars 436 are positioned on the horizontal beams 432 such that the cover assembly 408 may be coupled to the frame 404 without removing the cross-bars 436. When the cover assembly 408 is mounted on the frame 404, the cover assembly 408 is positioned at least partially above the cross-bars 436.

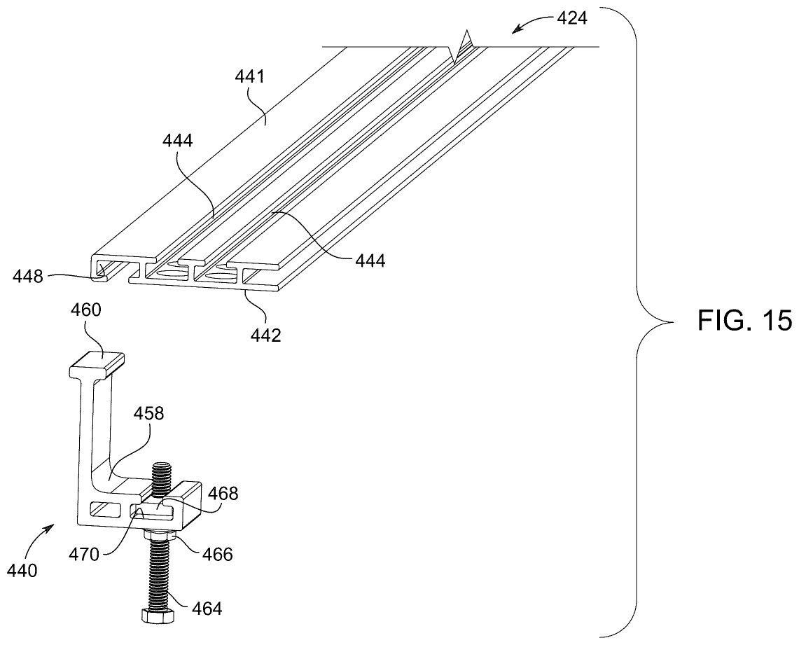

With reference to FIGS. 13-15, the foundation rails 424 are elongated along the longitudinal direction L. Each foundation rail 424 is couplable to the truck via clamping brackets 440. The foundation rails 424 each include a first side 441 facing the horizontal beams 432 and a second side 442 opposite the first side 441. Each foundation rail 424 includes a plurality of first channels 444 in the first side 441 and a second channel 448 in the second side 442. In some examples, the foundation rail 424 may only include one first channel 444. The channels 444, 448 are elongated along the longitudinal direction L. In some examples, the foundation rails 424 may include only one first channel 444. The openings of the first channels 444 in the first side 441 have smaller widths than the remainders of the first channels 444. The opening of the second channel 448 in the second side 442 has a smaller width than the remainder of the second channel 448.

With continued reference to FIGS. 13-15, the clamping brackets 440 each have a main body 458 and an attachment flange 460 extending from the main body 458. The main body 458 has an L-shape. The attachment flange 460 in the illustrated example is planar. In other embodiments, the attachment flange 460 may have an L-shape (as shown in FIG. 3a at 231). In other embodiments, the attachment flange 460 may include a first planar portion extending from the main body 458 and a second planar portion extending from the main body 458 and angled relative to the first planar portion (also shown in FIG. 3a at 231). A bolt 464 extends through the main body 458. The bolt 464 may be coupled to the main body 458 via a nut 466 and an anchor bar 468, which is positioned in a bracket channel 470 of the main body 458.

To couple the foundation rail 424 to the truck, the attachment flange 460 is inserted into the second channel 448 of the foundation rail 424. Specifically, the attachment flange 460 may be inserted into an end of the second channel 448. The clamping brackets 440 can then slide along the second channel 448 and can be positioned at various positions along the length L to accommodate different geometries of different truck beds. Because the width of the attachment flange 460 is wider than the opening of the second channel 448, the clamping bracket 440 is retained on the foundation rail 424. The foundation rail 424 is then positioned on a rail or wall of the truck bed and the bolt 464 is tightened on the rail of the truck bed to secure the foundation rail 424 on the truck bed. The rail of the truck bed is sandwiched between the foundation rail 424 and the bolts 464 of the clamping brackets 440. When the bolts 464 are tightened, the attachment flange 460 is square with the foundation rail 424 within the second channel 448.

With reference to FIG. 14b, seals 426 may be positioned under both of the foundation rails 424 such that the seals 426 are sandwiched between the truck and the foundation rails 424 when the foundation rails 424 are coupled to the truck. The seals 426 are positioned on the second sides 442 of the foundation rails 424. The seals 426 are planar and extend along the lengths of the foundation rails 424. The seals 426 are at least partially compressed against the truck to prevent leaks by the weight of the frame 404 and by clamping via the clamping brackets 440. The seals 426 may be rubber or foam.

With reference to FIGS. 13, 14a and 16a, the plurality of posts 428 are removably coupled to the foundation rails 424. The plurality of posts 428 each include a plurality of slots 474. In other examples, the posts 428 may only include a single slot. In some examples, the slot or slots 474 may be elongated. In other examples, the slot or slots 474 may be circular or square. In the illustrated example, a bracket 478 including a plurality of slots 480 corresponding to the plurality of slots 474 of the vertical post 428 is positioned on the post 428. In some examples, the bracket 478 may include a single slot. In some examples, the slot or slots 480 may be elongated. In other examples, the slot or slots 480 may be circular or square. In some examples, the bracket 478 may be omitted.

To couple the posts 428 to the foundation rails 424, fasteners 488 are positioned in anchor bars 484, and the anchor bars 484 and fasteners 488 are positioned in the first channels 444 of the foundation rails 424. Specifically, the fasteners 488 and anchor bars 484 may be inserted into an end of the first channels 444. Because the anchor bars 484 have larger widths than the openings of the first channels 444 in the first sides 441, the anchor bars 484 and fasteners 488 are retained in the first channels 444. The posts 428 are then positioned on the first sides 441 of the foundation rails 424. The slots 474 of the posts 428 are positioned around the fasteners 488. Further, the slots 480 of the bracket are positioned around the fasteners 488. Nuts 492 are then tightened on the fasteners 488 to secure the posts 428 to the foundation rails 424. In some examples, a single fastener, anchor bar, and nut may be used for each post 428.

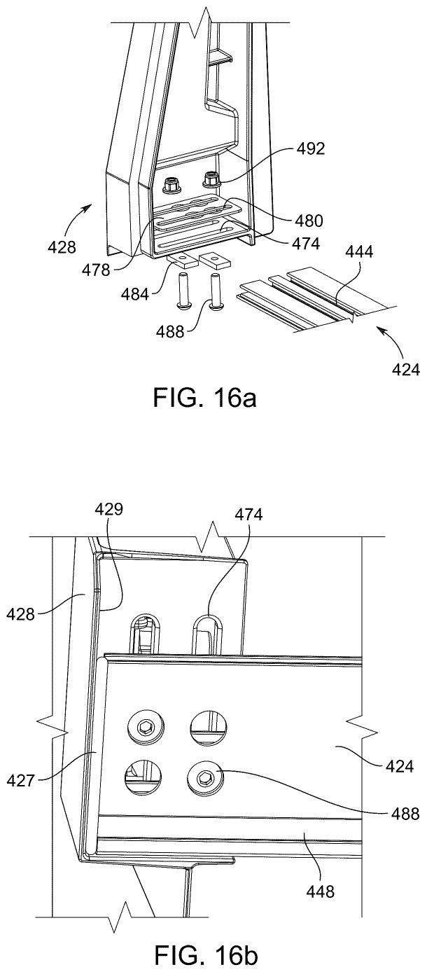

With reference to FIG. 16b, seals or gaskets 427 may be positioned between each of the posts 428 and the foundation rails 424. Specifically, the seals or gaskets 427 may be positioned between each end of the foundation rails 424 and each respective post 428. The seals or gaskets 427 and the ends of the foundation rails 424 may each be positioned in a recess 429 defined by a respective post 428. The posts 428 and foundation rails 424 may be power coated aluminum. The seals or gaskets 427 may be rubber or foam. Fastening of the posts 428 and the foundation rails 424 together compresses the seals or gaskets 427.

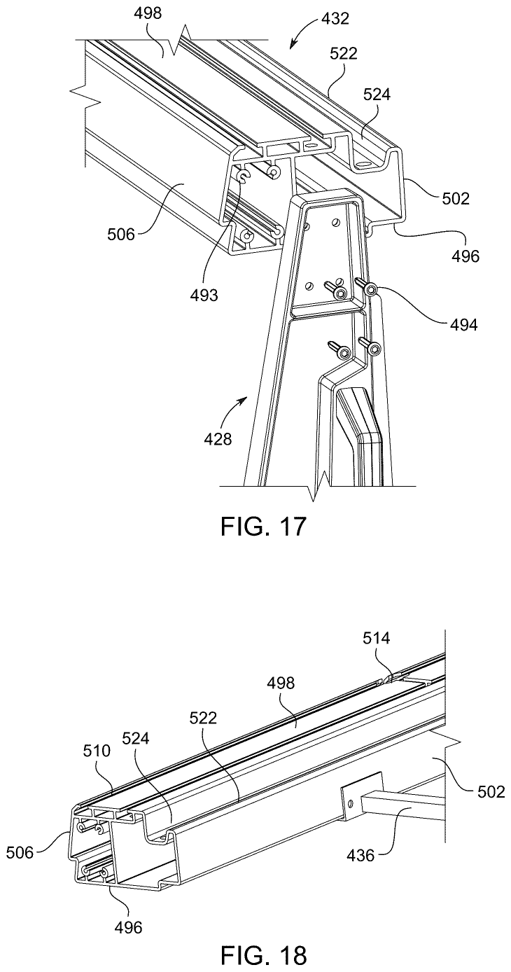

With reference to FIG. 17, the horizontal beams 432 each have a plurality of C-shaped projections 493 configured to receive fasteners 494 to couple the horizontal beams 432 to the posts 428. In the illustrated example, the horizontal beams 432 each include four C-shaped projections 493 configured to receive four fasteners 494 on each end. In other examples, the horizontal beams may include fewer or more C-shaped projections configured to receive fewer or more fasteners on each end.

The horizontal beams 432 may be sealed at each end similar to the horizontal beams 432 discussed above with respect to FIG. 8e. Specifically, a seal or gasket 245 may be sandwiched between each end of each horizontal beam 432 and between each respective vertical post 428. The seals or gaskets 245 may be rubber, and the horizontal beams 432 and vertical posts 428 may be made of powdered aluminum. Fastening of the posts 428 and the horizontal beams 432 together compresses the seals or gaskets.

With reference to FIGS. 17 and 18, the horizontal beams 432 each define a first side 496 facing the foundation rail 424 and a second side 498 opposite the first side 496. Each of the horizontal beams 432 defines a third side 502 extending between the first side 496 and the second side 498, and a fourth side 506 opposite the third side 502. The third sides 502 of the horizontal beams 432 face each other. The cross-bars 436 are mounted to and extend between the third sides 502 of the horizontal beams 432. The cross-bars 436 are positioned closer to the first sides 496 than the second sides 498. The cross-bars 436 are mounted on the first sides 496 and the third sides 502. In some examples, the cross-bars 436 may be mounted on only the third sides 502 adjacent the first sides 496. In some examples, the cross-bars 436 may be mounted on only the first sides 496.

The horizontal beams 432 each have channels 510 positioned in the second side 498. For each channel 510, the opening of the channel 510 in the second side 498 has a smaller width than the remainder of the channel 510. The horizontal beams 432 further include insertion openings 514 positioned along the channels 510 with larger widths than the openings of the channel 510. The insertion openings 514 are configured to receive anchor bars and fasteners that may have larger widths than the openings of the channels 510. Each of the horizontal beams 432 includes a ridge or lip 522 at least partially defining a recess 524. The ridge 522 defines a portion of the third side 502. The ridge 522 and the recess 524 are each elongated along the longitudinal direction L.

With reference to FIGS. 12, 19, and 20a, the storage module assembly 416 is selectively couplable to the frame 404. The storage module assembly 416 includes a base frame 526 and a door panel 528 pivotably coupled to the base frame 526. Similar to the side door assembly 420 discussed below, the door panel 528 may include a plurality of brackets, each configured to be coupled to a removable strap. A user may pull on the strap when lowering the door panel 528 from an open position to a closed position. The base frame 526 includes a bottom wall 530, a top wall 532 opposite the bottom wall 530, side walls 534 extending between the bottom wall 530 and the top wall 532, and a rear wall 536 extending between the side walls 534 and between the bottom wall 530 and the top wall 532. The storage module assembly 416 further includes dampers 529 that are each coupled to the base frame 526 at one end and the door panel 528 at the opposite end. The dampers 529 hold the door panel 528 in the open position. The dampers 529 may be gas springs.

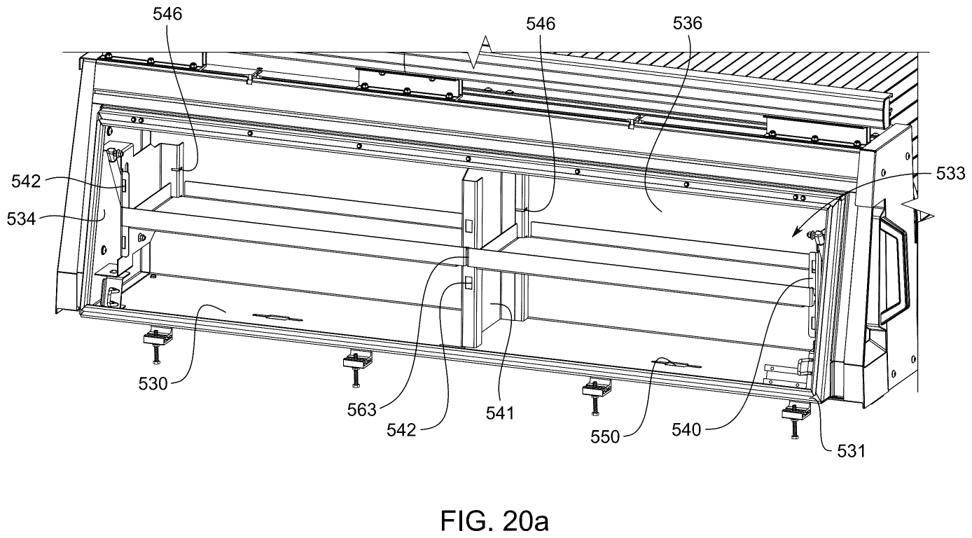

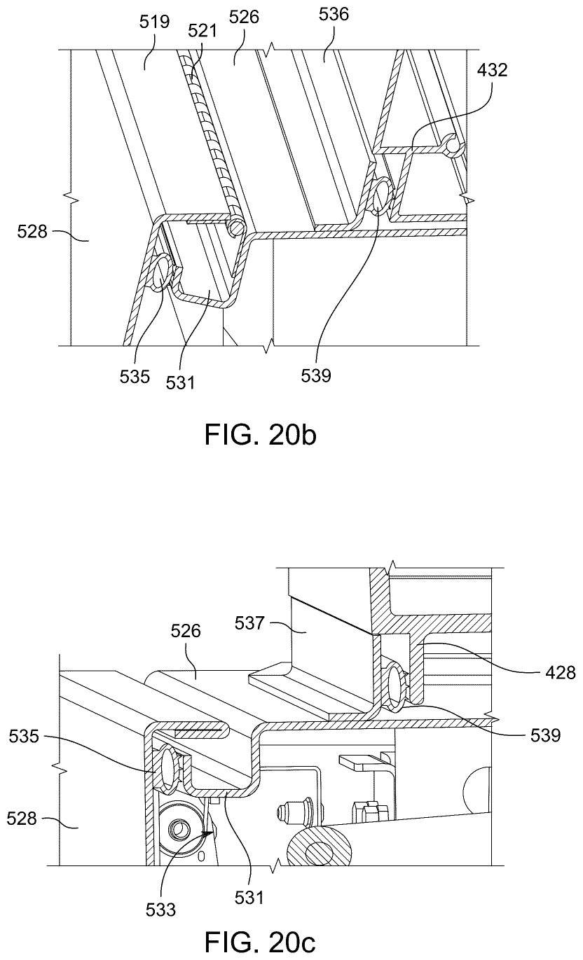

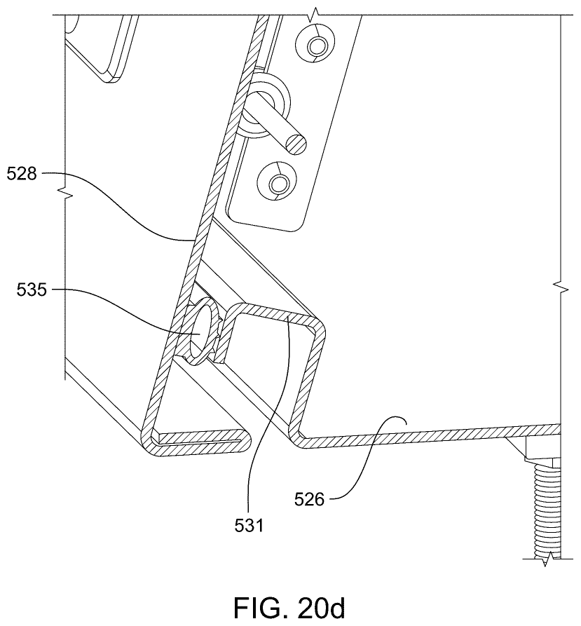

With reference to FIGS. 20a-d, the base frame 526 includes a gutter-shaped or U-shaped lip 531 around a perimeter of an opening 533. The door panel 528 includes a flange 519 around a perimeter thereof, and the flange 519 is configured to overlap an opening defined by the gutter-shaped lip 531. A pivot mechanism 521 is coupled at the top of the base frame 526 between a wall of the gutter-shaped lip 531 and the flange 519. In the closed position, the opening 533 is closed by the door panel 528. A plurality of seals 535 are coupled to either the door panel 528 or an outer surface of the gutter-shaped lip 531. Regardless, the plurality of seals 535 are configured to extend around the perimeter of the opening 533. The plurality of seals 535 are each elongated along a side of the opening 533. The plurality of seals 535 are adhered to the door panel 528. When the door panel 528 is in the closed position, the plurality of seals 535 engage the gutter-shaped lip 531. The gutter-shaped lip 531 and the door panel 528 compress the seals 535 to seal the opening 533 and to prevent water from entering an interior of the storage module assembly 416. The gutter-shaped lip 531 is configured to guide water from a top of the gutter-shaped lip 531 (FIG. 20b) down the sides of the gutter-shaped lip 531 (FIG. 20c) and out of the bottom of the gutter-shaped lip 531 (FIG. 20d). The seals 535 may be made of rubber. The base frame 526 and the door panel 528 may be made of powder-coated aluminum.

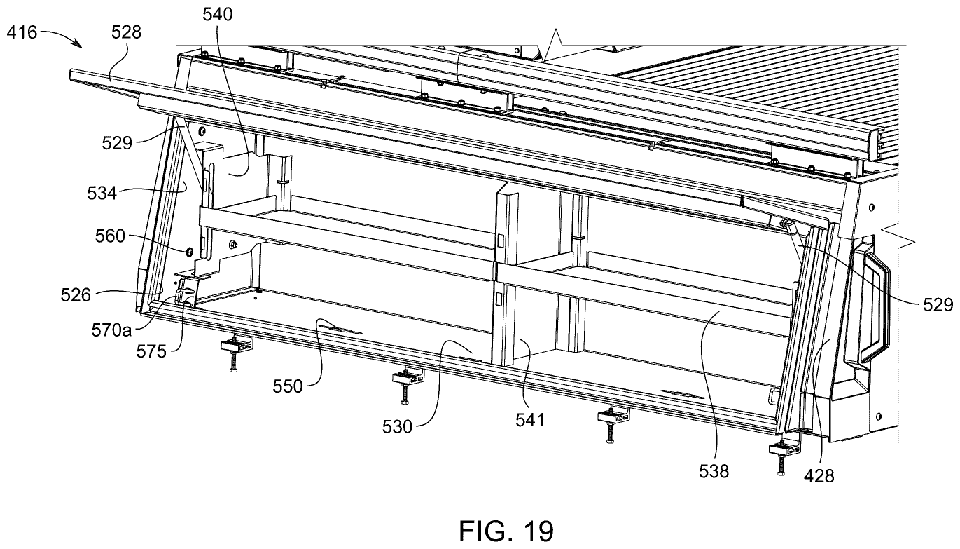

With reference to FIGS. 19-21b, the bottom wall 530 includes openings 550. When the storage module assembly 416 is coupled to the frame 404, the openings 550 are aligned with one of the first channels 444 of the foundation rails 424. Fasteners 552 extend through the openings 550, and nuts are threaded onto the fasteners 552. The nuts are each positioned in the respective first channel 444 of the foundation rail 424. The fastener 552 is tightened to secure the storage module assembly 416 on the foundation rail 424. The storage module assembly 416 is further coupled to the posts 428 via fasteners 560. In some embodiments, similar to the side door assembly 420 discussed below, the top wall 532 may include openings such that the top wall 532 can be coupled to the horizontal beam 432 via fasteners.

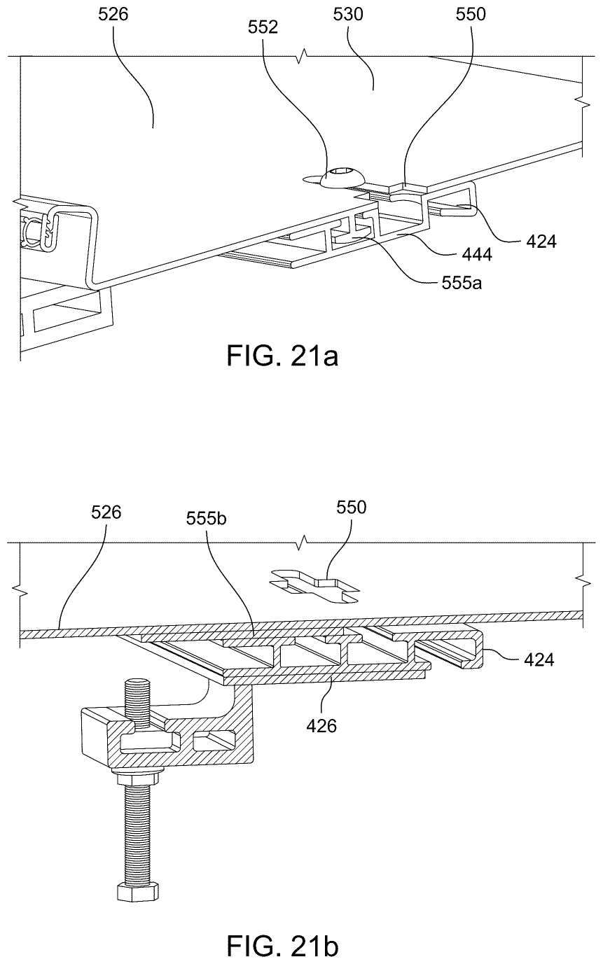

In the illustrated example, as shown in FIG. 21a, the storage module assembly 416 is coupled to the frame 404. Seals 555a may be positioned in the first channels 444 of the foundation rails 424 to seal the storage module assembly 416 to the frame 404. In other examples, as shown in FIG. 21b, a seal 555b may be coupled to the bottom wall 530 of the base frame 526. The seal 555b is adhered to the bottom wall 530. The seal 555b is planar and extends along a length of the bottom wall 530. When the storage module assembly 416 is inserted into the frame 404, the seal 555b is sandwiched between and compressed by the bottom wall 530 of the base frame 526 and the foundation rail 424. The base frame 526 and the foundation rail 424 may be made of powdered coated aluminum. The seals 555a, 555b may be made of rubber or foam.

Referring back to FIGS. 20b and 20c, the base frame 526 includes a plurality of flanges 537. One of the flanges 537 is coupled to each of the top wall 532 and the side walls 534 of the base frame 526. A plurality of seals 539 are coupled to the flanges 537. Specifically, the seals 539 are adhered to the flanges 537. When the storage module assembly 416 is inserted into the frame 404, the plurality of seals 539 are sandwiched between and compressed by the flanges 537 and the frame 404. Specifically, the plurality of seals 539 on the flanges 537 on the side walls 534 are compressed between the flanges 537 and the vertical posts 428. The seal 539 on the flange 537 on the top wall 532 is sandwiched between and compressed by the flange 537 and the horizontal beam 432. The frame 404 and the flanges 537 may be made of powdered coated aluminum. The seals 539 may be made of rubber or foam.

Referring back to FIGS. 19 and 20a, each of the storage module assembly 416 includes a plurality of removable shelves 538, first shelf mounting brackets 540 removably coupled to the base frame 526, and a second shelf mounting bracket 541 removably coupled to the base frame 526 and positioned between the first shelf mounting brackets 540. In the illustrated example, the first shelf mounting brackets 540 are supported by and coupled to brackets 575, which are in turn fastened to the bottom wall 530. In some examples, the first shelf mounting brackets 540 may be coupled to the side walls 534. In some examples, the first shelf mounting brackets 540 may be coupled to the rear wall 536. In some examples, the second shelf mounting bracket 541 may be coupled to the bottom and top walls 530, 532. In some examples, the second shelf mounting bracket 541 may be coupled to the rear wall 536. In some examples, the storage module assembly 416 may include a single removable shelf extending between the first shelf mounting brackets 540. The first and second shelf mounting brackets 540, 541 include a plurality of front openings 542 and a plurality of rear openings 546 corresponding to the front openings 542 of the mounting brackets 540, 541. The removable shelves 538 are positioned in the openings 542, 546 such that the shelf 538 is supported by the shelf mounting brackets 540, 541. In other embodiments, the front openings may be in the side walls 534 and the rear openings may be in the rear wall 536, such that the shelves are supported by the base frame 526 without the brackets 540. The removable shelf 538 includes hooks 563 that are received in the openings 542. In the illustrated embodiment, the dampers 529 are also pivotably mounted on the first shelf mounting brackets 540, but in other embodiments, the dampers 529 may be pivotably mounted elsewhere (e.g., to the side walls 534).

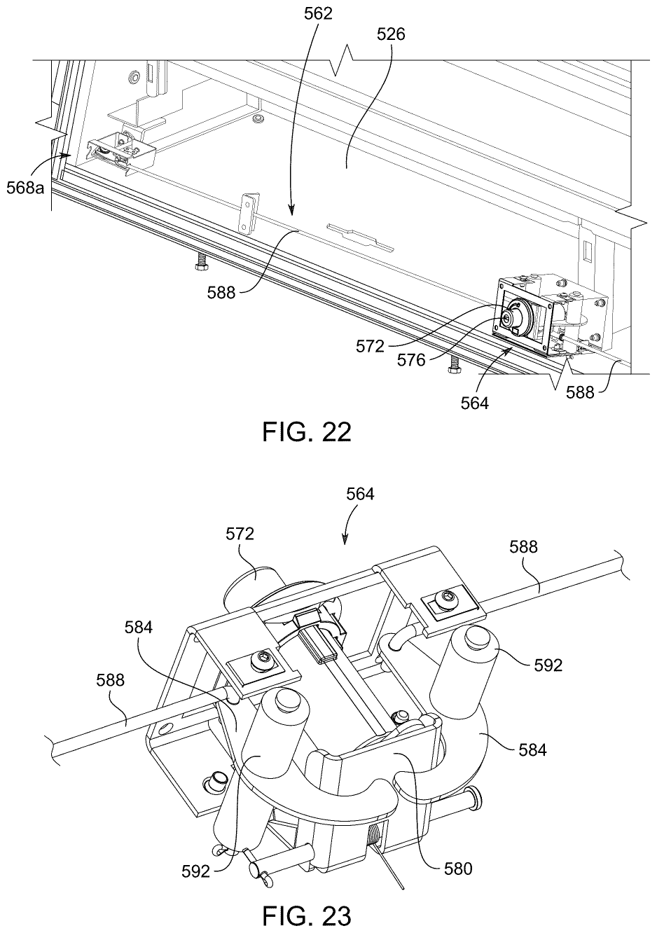

With reference to FIGS. 22 and 23, the storage module assembly 416 further includes a locking mechanism 562 configured to lock the door panel 528 to the base frame 526. The locking mechanism 562 includes a lock assembly 564 mounted to the door panel 528 and a pair of latch assemblies 568a configured to latch the door panel 528 to the base frame 526. The lock assembly 564 moves the latch assemblies 568a between a latched position and an unlatched position. The lock assembly includes a push button 572, a key lock 576 configured to selectively lock and unlock the push button 572, a lever 580 positioned at an end of the push button 572, and a pair of pivoting arms 584 abutting the lever 580. When the push button 572 is locked by the key lock 576, the push button 572 is fixed relative to the pivoting arms 584. When the push button 572 is unlocked, the push button 572 may be pressed toward the lever 580 and the pivoting arms 584. The pivoting arms 584 each contact the lever 580 at a first end and are coupled to rods at a second end. The pivoting arms 584 are each pivotable about a respective shaft 592 positioned between the first end and the second end.

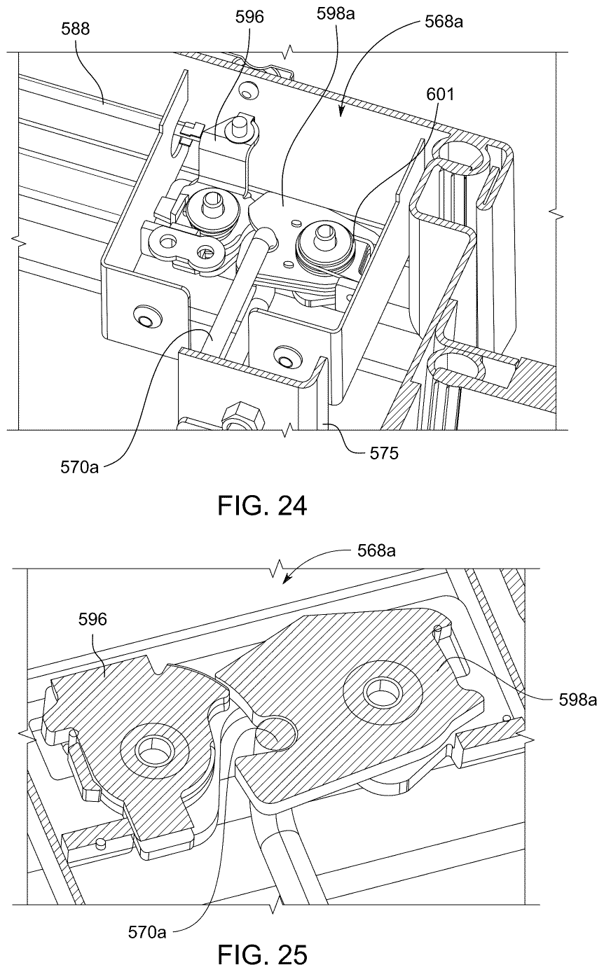

With reference to FIGS. 24 and 25, the latch assemblies 568a are mirror identical. Each latch assembly 568a includes a bar 570a coupled to the base frame 526, a cam 596 coupled to the rod 588, and a latch 598a configured to receive the bar 570a. The bar 570a is coupled to the base frame 526 via the bracket 575. The latches 598a are biased toward an unlatched position via springs 601. In the latched position, the bars 570a are received by the latches 598a, and the cams 596 engage the bars 570a to inhibit rotation of the bars 570a. To unlatch the door panel 528, a user may push on the push button 572 so that the push button 572 presses on the lever 580. The lever 580 then presses on the first ends of the pivoting arms 584. The pivoting arms 584 then pivot about the shafts 592, and the second ends of the pivoting arms 584 move inward towards the push button 572. The rods 588 coupled to the second ends of the pivoting arms 584 move inward toward the lock assembly 564. When the rods 588 move inward, the cams 596 rotate to disengage the latches 598a. As a result, the latches 598a may rotate via bias of the springs 601 to release the bars 570a so that the door panel can be pivoted away from the base frame 526.

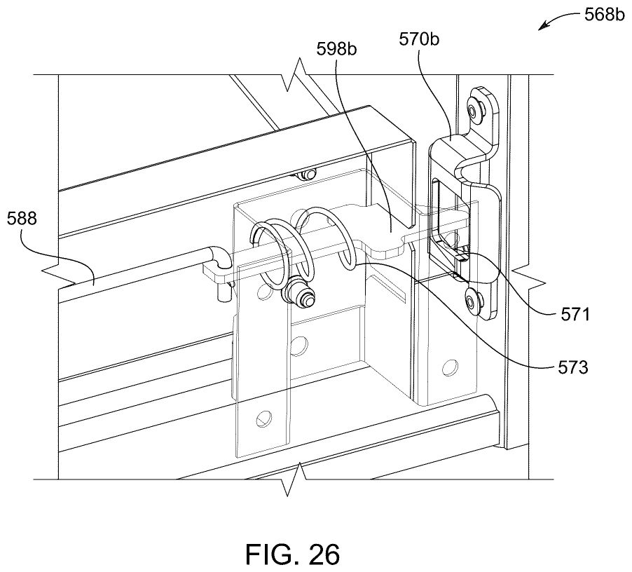

FIG. 26 illustrates another example of a latch assembly 568b that may be part of the locking mechanism 562 and may be used as a pair of latch assemblies 568b with the lock assembly 564 and rods 588. Each latch assembly 568b includes a bracket 570b coupled to the base frame 526 and a pin 598b slidably mounted on the door panel 528. The pins 598b are each movable in and out of a respective opening 571 of one of the brackets 570b. The pins 598b are each coupled to a respective one of the rods 588. The pins 598b are biased toward the brackets 570b via springs 573. When the rods 588 move inward, the pins 598b move inward as well to disengage the brackets 570b and thereby unlatch the door panel 528. Specifically, the pins 598b slide out of the openings 571 of the brackets 570b. When the push button 572 is released, the pins 598b move back toward the brackets 570b via springs 573.

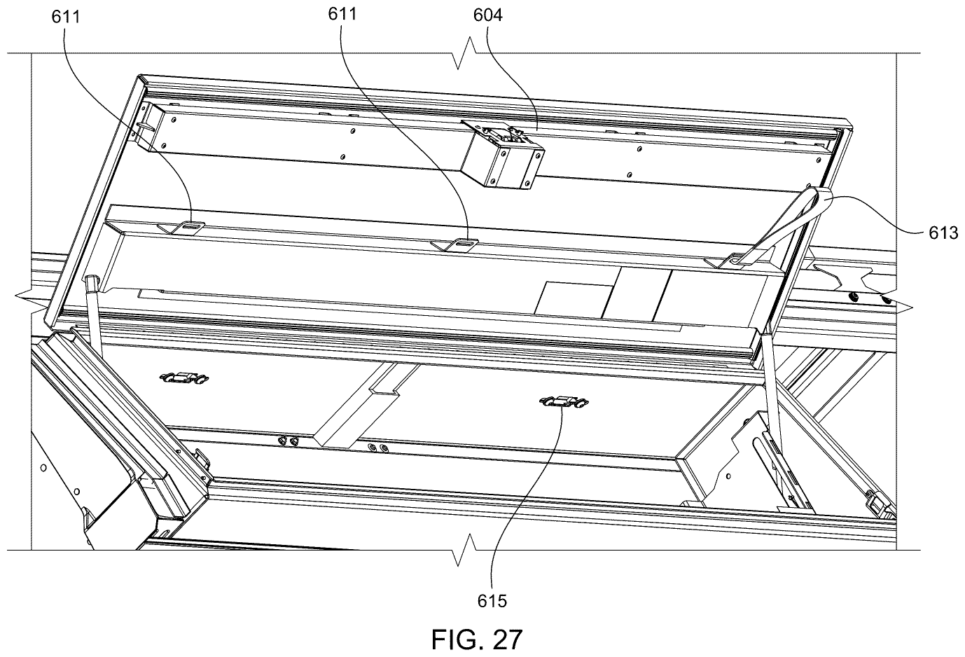

With reference to FIGS. 12 and 27, the side door assembly 420 is removably couplable to the frame 404. The side door assembly 420 has a similar structure to the storage module assembly 416. Like the storage module assembly 416, the side door assembly 420 has a base frame 602, a door panel 604, a bottom wall 606, a top wall 608, side walls 610, and a locking mechanism 612. For the sake of brevity, the details of these components will not be repeated. Further, as shown in FIG. 27, similar to the base frame, the door panel 604 may include a plurality of brackets 611, each configured to be coupled to a removable strap 613. A user may pull on the strap when lowering the door panel 604 from an open position to a closed position. In some embodiments, the top wall 608 may include openings 615 such that the top wall 608 can be coupled to the horizontal beam 432 via fasteners. Unlike the storage module assembly 416, the side door assembly 420 does not include shelves or a rear wall. Further, the bottom wall of the side door assembly 420 is shorter than the bottom wall 530 of the storage module assembly 416. Because of these differences, the side door assembly 420 provides access to the truck bed, rather than an enclosed storage compartment, as does the storage module assembly 416.

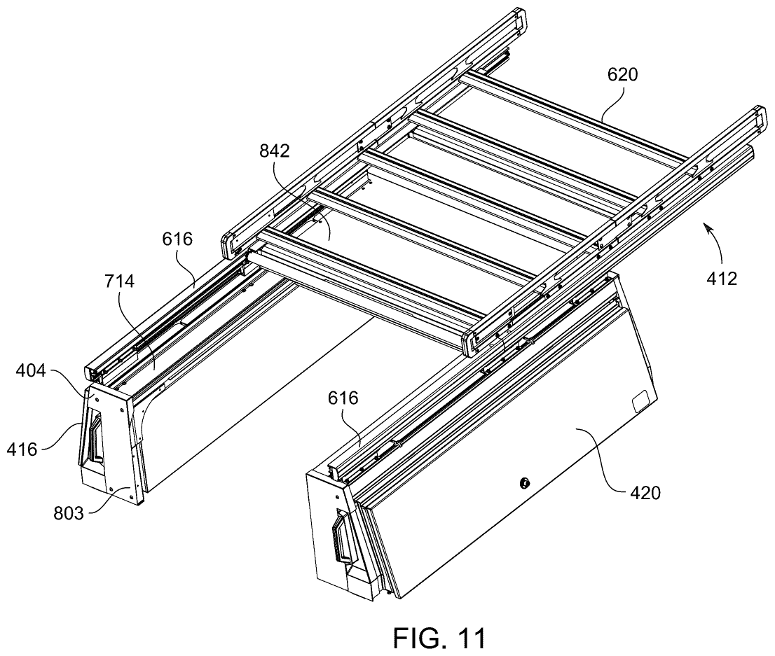

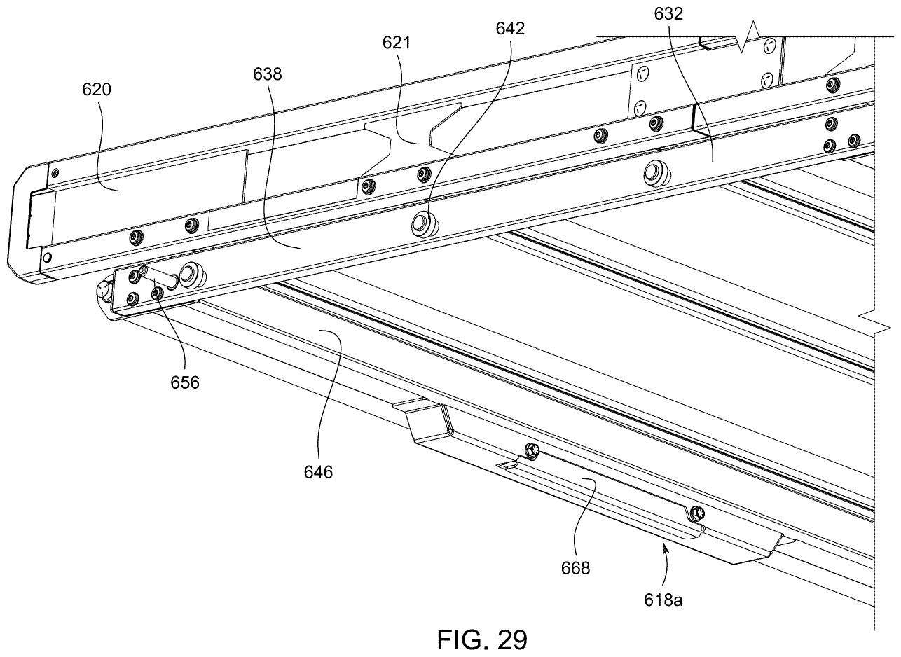

With reference to FIGS. 9-12, the sliding ladder rack assembly 412 is selectively mountable to the frame 404. The sliding ladder rack assembly 412 has a pair of track members 616, each selectively couplable to the frame 404, and a rack 620 slidably supported on the track members 616. The rack 620 is movable between an extended position (FIG. 9) and a retracted position (FIG. 11). The rack 620 is slidable along the longitudinal direction L. The sliding ladder rack assembly 412 further includes a locking mechanism 618a (FIG. 29) configured to lock the rack 620 relative to the track members 616. The locking mechanism 618a may lock the rack 620 in the forward position and the rearward position. The locking mechanism 618a may also lock the rack 620 in intermediate positions between the forward position and the rearward position.

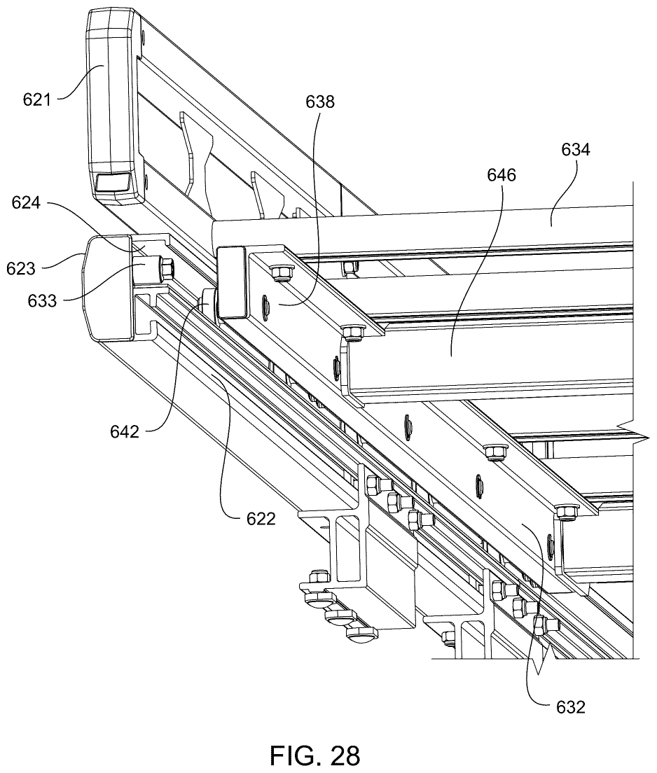

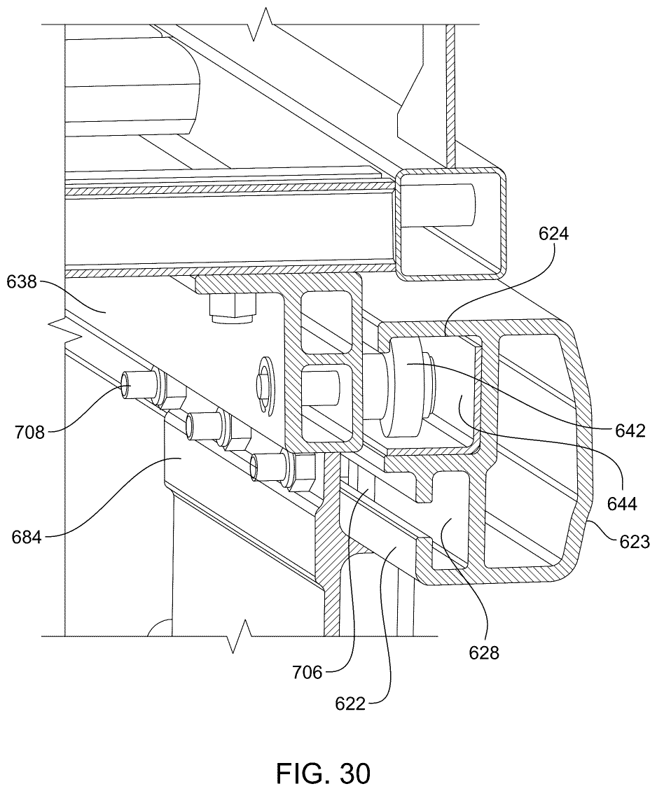

With continued reference to FIGS. 28-30, the track member 616 has a first side 622 and a second side 623 opposite the first side 622. The first sides 622 of the track members 616 face each other. The track members 616 each define a first channel 624 and a second channel 628. For each second channel 628, the opening of the second channel 628 in the first side 622 has a smaller width than the remainder of the second channel 628. The track member 616 further includes stop members 633 positioned at each end of the first channel 624. In the illustrated example, the stop members 633 are cylindrical. In other examples, the stop members 633 may have a different form, such as an L-shaped bracket.

With continued reference to FIGS. 28-30, the rack 620 includes a mount portion 632 slidably coupled to the track members 616 and a rack or support portion 621 supported by the mount portion 632. The rack 620 further includes a rolling rod 619 (FIG. 9) configured to allow a user to roll ladders or cargo onto the rack portion 621. The rolling rod 619 may also be used as a handle when moving the rack 620. In the illustrated example, the rack portion 621 is separate from and coupled to the mount portion 632. In other examples, the rack portion 621 and the mount portion 632 may be formed as one piece. The rack portion 621 includes a plurality of support beams 634 configured to support a ladder or other cargo. The mount portion 632 includes a pair of mount beams 638, each corresponding to a respective track member 616, and a plurality of rollers 642 positioned on and rotatable relative to the mount beams 638. Although rollers 642 are used in the illustrated embodiment, sliding plates having a low-friction interface may be used in other embodiments in lieu of rollers. The mount beams 638 extend along the longitudinal direction L.

The rollers 642 are positioned in the first channel 624. When the rollers 642 roll in the first channel 624, the rack 620 slides relative to the track members 616. The rollers 642 are spaced from each other to ease movement and disperse stress when a load is placed on the rack 620. The stop members 633 stop the rollers 642 from moving out of the ends of the first channels 624. In other words, the stop members 633 inhibit the rollers 642 from exiting the track members 616.

In the illustrated example, sleeves 644 are positioned in the first channels 624 such that the rollers 642 contact the sleeves 644 rather than the track members 616. In some examples, the sleeves 644 may be omitted. In the illustrated example, the sleeves 644 are formed from steel, and the track members 616 are formed from aluminum. The sleeves 644 may be replaced to increase the life of the track members 616 at a cost lower than that for replacing the entire track members 616. The mount portion 632 further includes a plurality of cross-bars 646, or beams, extending between the mount beams 638. The cross-bars 646 stabilize the mount beams 638 and the rollers 642. As such, the rack 620 may withstand heavier loads over time. Further, the cross-bars 646 prevent the rollers 642 and the mount beams 638 from cambering as the load on the rack 620 bounces or increases. As a result, the life of the rack 620 and the track members 616 is increased.

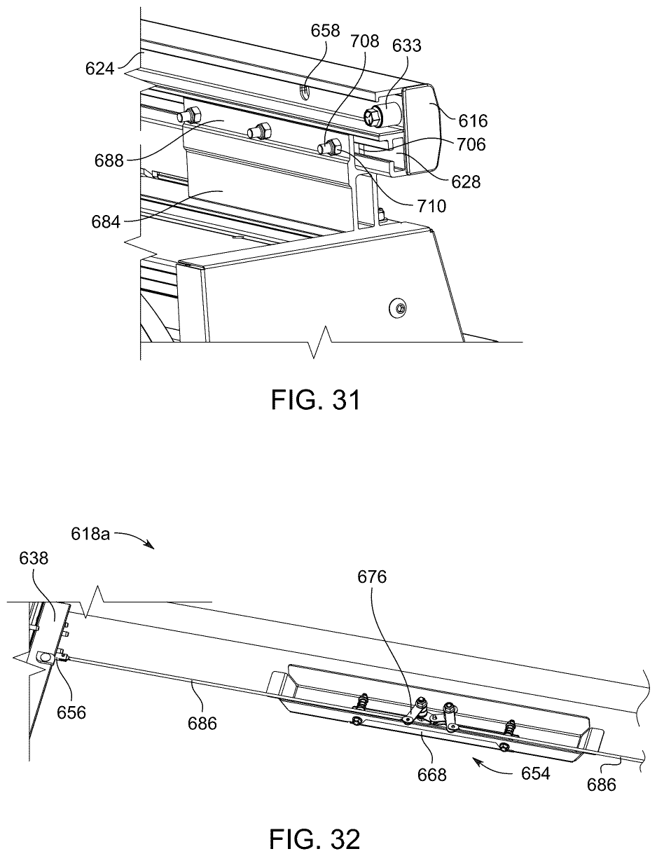

With reference to FIGS. 29 and 31-33, the locking mechanism 618a includes an actuating assembly 654 mounted on the rack 620, a pair of pins 656 movable by the actuating assembly 654, and openings 658 (FIG. 31) positioned in the track members 616 along the length L. The openings 658 are positioned in the first channels 624. The openings 658 are positioned at various longitudinal positions along the first channels 624 such that the rack 620 can be locked at different longitudinal positions (e.g., the forward position, the rearward position, the intermediate positions, etc.). The locking mechanism 618a is biased toward a locked condition via springs 662.

As illustrated, the pins 656 are each supported in the mount beams 638 such that the pins 656 only translate linearly between an extended position and a retracted position. In the extended position, the pins 656 project into a pair of the openings 658 (FIG. 31) of the track members 616 to lock the rack 620 relative to the track members 616. In the retracted position, the pins 656 are withdrawn from the openings 658.

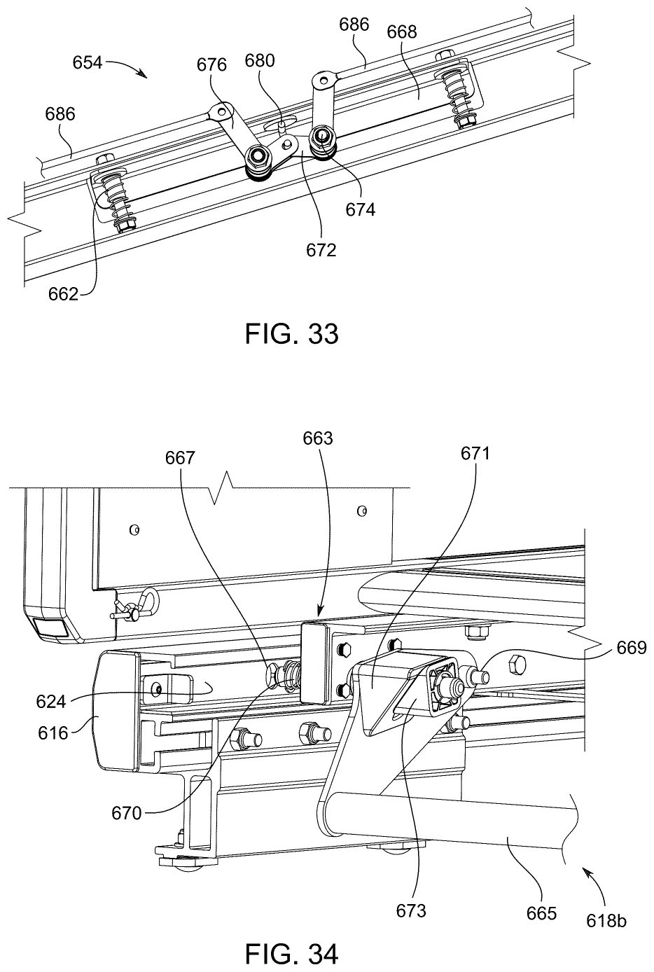

As illustrated in FIG. 33, the actuating assembly 654 includes an actuator 668 (e.g., a squeeze lever) configured to be actuated by the user to unlock the locking mechanism 618a. The actuating assembly 654 further includes a pair of shafts 674, a pair of first arms 672 each coupled to a respective one of the shafts 674, and a pair of second arms 676 each coupled to a respective one of the shafts 674. The first arms 672 and the second arms 676 are rotationally fixed to one another such that rotation of the first arms 672 causes rotation of the second arms 676. The first arms 672 are coupled to the actuator 668 via a bar 680. The bar 680 is U-shaped. Each of the second arms 676 is coupled to a rod 686. The rods 686 are each coupled to one of the pins 656.

To unlock the locking mechanism 618a and retract the pins 656, a user may press on the actuator 668. When the actuator 668 is pressed toward the first arms 672, the first arms 672 rotate about the shafts 674. In turn, the second arms 676 rotate with the first arms 672 to put the rods 686 inward toward each other. When the rods 686 move inward, the pins 656 move inward with the rods 686 and are withdrawn from the openings 658. The rack 620 may then be moved relative to the track members 616. Once the actuator 668 is released and the pins 656 are positioned at a pair of the openings 658, the locking mechanism 618a returns to the locked condition due to the bias of the springs 662.

FIG. 34 illustrates another example of a locking mechanism 618b that may be used with the rack 620 and track members 616. The locking mechanism 618b includes a pair of latching assemblies 663 (only one shown) and an actuator handle 665 configured to move the latching assemblies 663 between a latched position (shown in FIG. 34) and an unlatched position. Each latching assembly 663 corresponds to a respective one of the track members 616. The latching assemblies 663 are mirror identical, so only one assembly 663 and corresponding track member 616 will be shown and described for the sake of brevity. The latching assembly 663 includes an opening 667 positioned in the first channel 624 of the track member 616. The latching assembly 663 further includes an axle 669 mounted on the rack 620 and a pin 670 slidably positioned in the axle 669. The pin 670 is configured to move into the opening 667 in the latched position and out of the opening 667 in the unlatched position. The actuator handle 665 is pivotably coupled to the axle 669. The latching assembly 663 also includes a first wedge 671 fixed to the actuator handle 665 and pivotably coupled to the axle 669, and a second wedge 673 fixed to the pin 670. When the actuator handle 665 is rotated downward about the axle 669, the first wedge 671 forces the second wedge 673 to move up the first wedge 671. Due to the slopes of the wedges 671, 673, the second wedge 673 moves inward and pulls the pin 670 out of engagement with the opening 667.

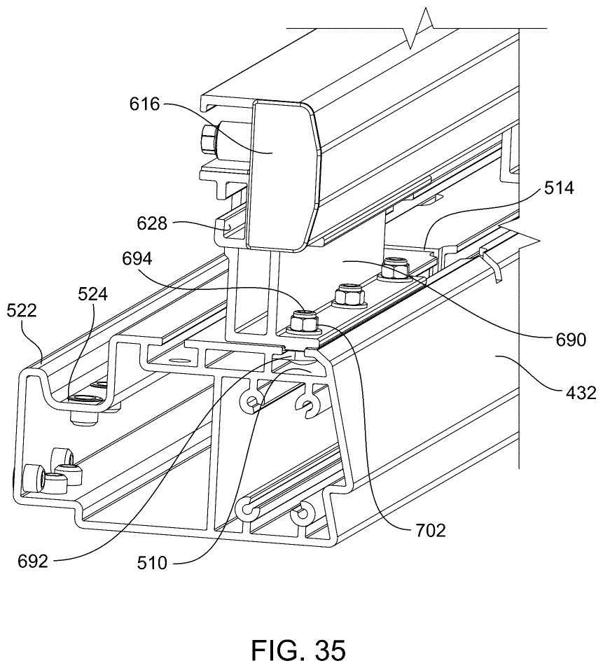

Referring back to FIGS. 31 and 35, the track members 616 are each selectively mounted to a respective horizontal beam 432 via mounting brackets 684. The mounting brackets 684 each include a first attachment portion 688 couplable to the track member 616 and a second attachment portion 690 couplable to the horizontal beam 432. With reference to FIG. 35, to couple one of the mounting brackets 684 to one of the horizontal beams 432, anchor bars 692 and fasteners 694 extending through the anchor bars 692 are positioned in the channel 510 of the horizontal beam 432. The anchor bars 692 have larger widths than the opening of the channel 510. The mounting bracket 684 is positioned on the horizontal beam 432, and the fasteners 694 extend through openings in the second attachment portion 690 of the mounting bracket 684. Nuts 702 are then tightened on the fasteners 694 to secure the second attachment portion 690 to the horizontal beam 432. With reference to FIG. 31, to couple one of the mounting brackets 684 to one of the track members 616, anchor bars 706 and fasteners 708 extending through the anchor bars 706 are positioned in the second channel 628 of the track member 616. The anchor bars 706 have larger widths than the width of the opening of the second channel 628. The mounting bracket 684 is positioned against the track member 616, and the fasteners 708 extend through openings in the first attachment portion 688 of the mounting bracket 684. Nuts 710 are then tightened on the fasteners 708 to secure the first attachment portion 688 to the track member 616.

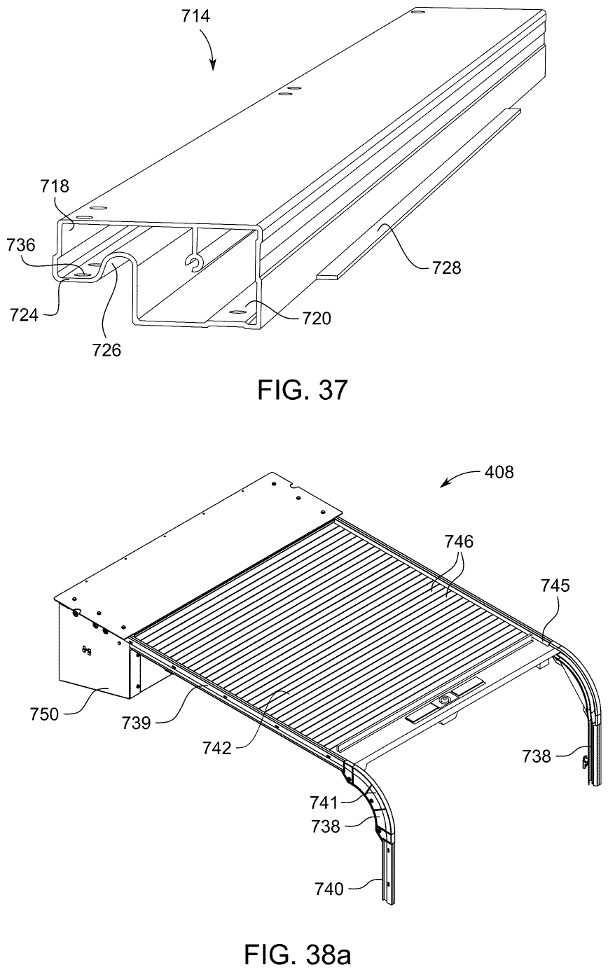

With reference to FIGS. 11, 36, and 37, a pair of intermediate beams 714 are selectively mounted on the frame 404. The horizontal beams 432 support the intermediate beams 714. The intermediate beams 714 are mirror identical. Each of the intermediate beams 714 includes an interlocking portion 718 and a support portion 720 extending from the interlocking portion 718. In the illustrated embodiment, the interlocking portion 718 and the support portion 720 are formed as one piece. The interlocking portion 718 includes a ridge or lip 724 at least partially defining a recess 726. The ridge 724 and the recess 726 are each elongated along the longitudinal direction L. The support portion 720 includes a ledge 728. The ledge 728 is elongated along the longitudinal direction L.

To mount the intermediate beams 714 on the horizontal beams 432, the intermediate beams 714 interlock with the horizontal beams 432. The interlocking engagement of the intermediate beams 714 to the horizontal beams 432 prevents water from entering the truck bed. Specifically, the ridges 724 of the intermediate beams 714 are positioned in respective recesses 524 of the horizontal beams 432. Likewise, the ridges 522 of the horizontal beams 432 are positioned in respective recesses 726 of the intermediate beams 714. Because the ridges 522, 724 project in opposite directions, the intermediate beams 714 are inhibited from moving inward toward each other or outward away from each other. The intermediate beams 714 are then secured to the horizontal beams 432 via a plurality of fasteners 732 and rivet nuts 734. The rivet nuts 734 are positioned in the horizontal beams 432. The fasteners 732 extend through a plurality of holes 736 in the intermediate beams 714 and are threaded into the rivet nuts 734 in the horizontal beams 432 to secure the intermediate beams 714 to the horizontal beams 432.

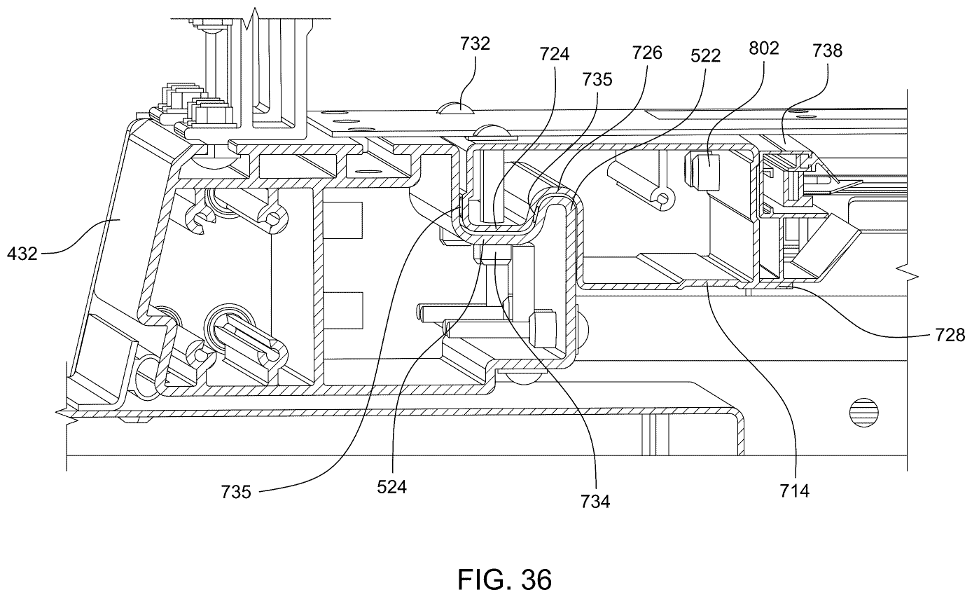

With continued reference to FIG. 36, seals 735 may be positioned and sandwiched between the intermediate beams 714 and the horizontal beams 432 to seal the intermediate beams 714 to the horizontal beams 432. In each pair of the intermediate beams 714 and the horizontal beams, the seals 735 are positioned in the recess 524 of the horizontal beam 432 on opposing sides of the ridge 724 of the intermediate beam 714. The seals 735 may be formed from rubber or foam.

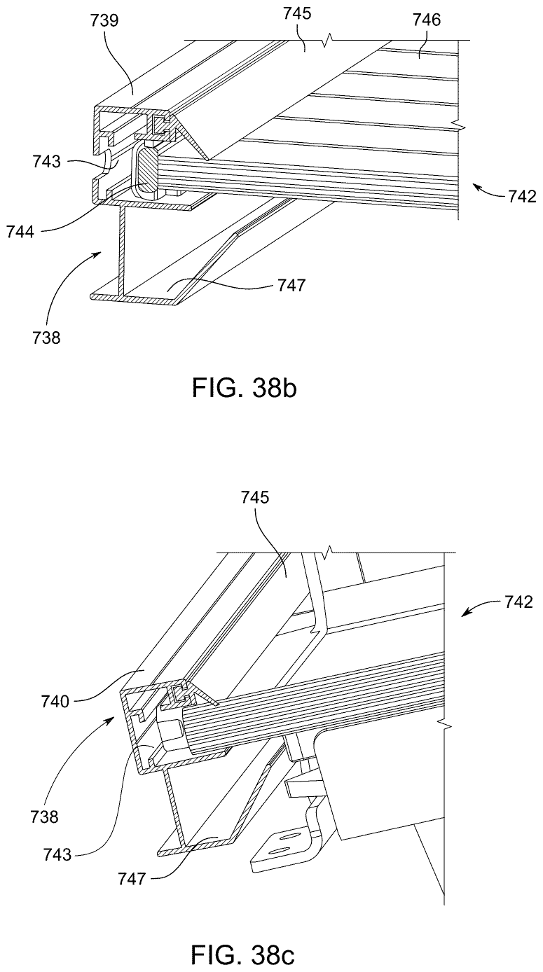

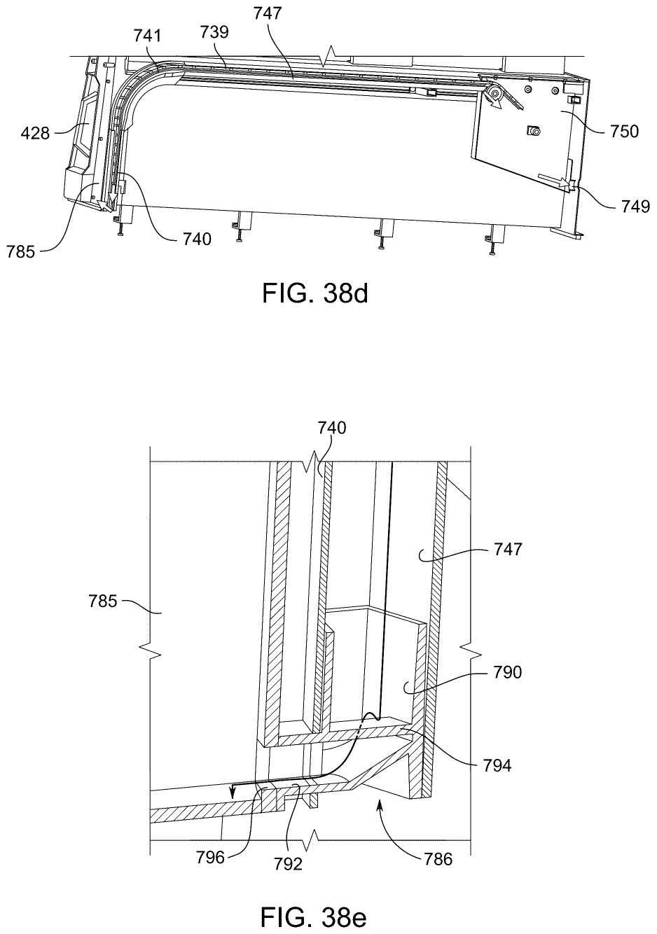

With reference to FIG. 12, the cover assembly 408 is selectively mountable to the frame 404. In the illustrated example, the cover assembly 408 has a roll-top cover. In other examples, the cover assembly 408 may have another type of cover, such as the telescoping cover discussed above with respect to FIGS. 1a-8. With reference to FIGS. 9, 11, and 38a, the cover assembly 408 includes a pair of track members 738 and a cover 742 extending between and slidable in the track members 738. The track members 738 are fastened to the intermediate beams 714. The cover 742 is movable between a closed position (FIG. 9), at least one intermediate position (FIG. 38a), and an open position (FIG. 11). Specifically, the cover 742 is slidable between the open, closed, and intermediate positions. In the open position, the truck bed is accessible from the top end 425 and rear end 422 of the frame 404. In the closed position, the cover 742 encloses the truck bed from the top end 425 and the rear end 422 of the frame 404. In the intermediate position, the cover 742 is positioned between the open position and the closed position. In the intermediate position, the truck bed is accessible from the rear end 422 of the frame 404. There may be more than one intermediate position.

With continued reference to FIGS. 9, 11, and 38a-c, the track members 738 extend along the rear end 422 and top end 425 of the frame 404. As shown, each track member 738 has a horizontal portion 739, a vertical portion 740, and a curved portion 741 between the horizontal portion 739 and the vertical portion 740. The track members 738 define a track 743. The cover 742 includes a plurality of panels 746 coupled to one another on both sides by a plurality of end caps 744. The end caps 744 are supported by and slidable in the tracks 743 of the track members 738. Adjacent panels 746 are pivotably coupled to one another so the cover 742 can conform to the curved path defined by the track members 738. The track members 738 further include wiper seals 745 that extend from at least the horizontal portion 739 and the vertical portion 740 thereof. The wiper seal 745 abuts the top surfaces of the panels 746.

Additionally, the track members 738 each include a flange 747 that is configured to guide water that enters into the track members 738 away from the truck bed. As shown, the flange 747 projects inwardly towards the truck bed and overlaps the sides of the cover 742. As shown in FIG. 38d, the flange 747 extends along the length of the track member 738. Specifically, the flange 747 is positioned on the horizontal portion 739, the vertical portion 740, and the curved portion 741. As shown, the water that enters the flange 747 will be directed toward the rear end 422 or toward the front end 421. As shown, the water that enters the flange 747 will be directed toward the frame 404 at the rear end 422 or toward a cover housing 750 at the front end 421. The water then is routed out of the truck cap assembly 400 through an intermediate post 785 of the frame 404 or the cover housing 750. The intermediate post 785 and the cover housing 750 will be discussed in more detail below. In some examples, the water that enters the flange 747 may be directed toward the frame 404.

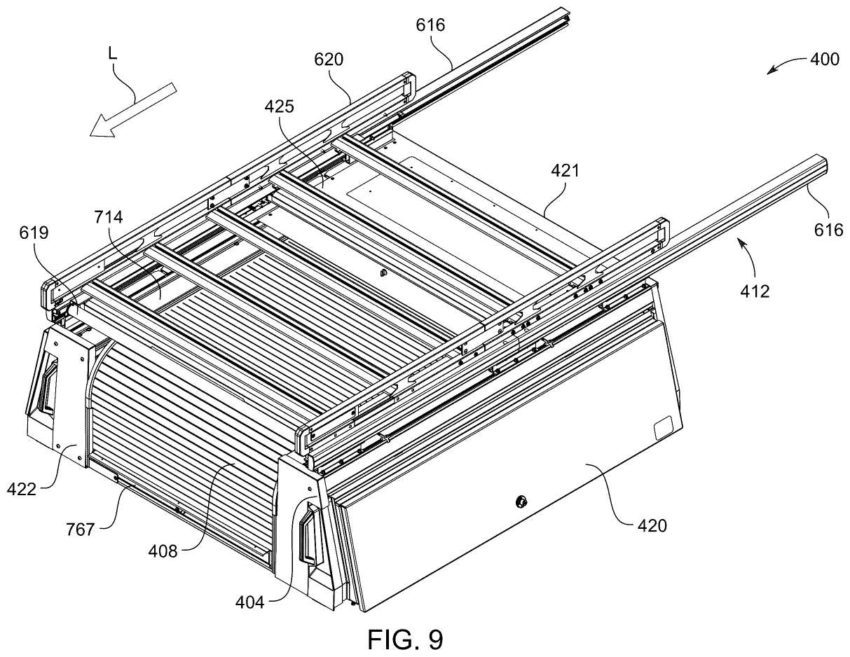

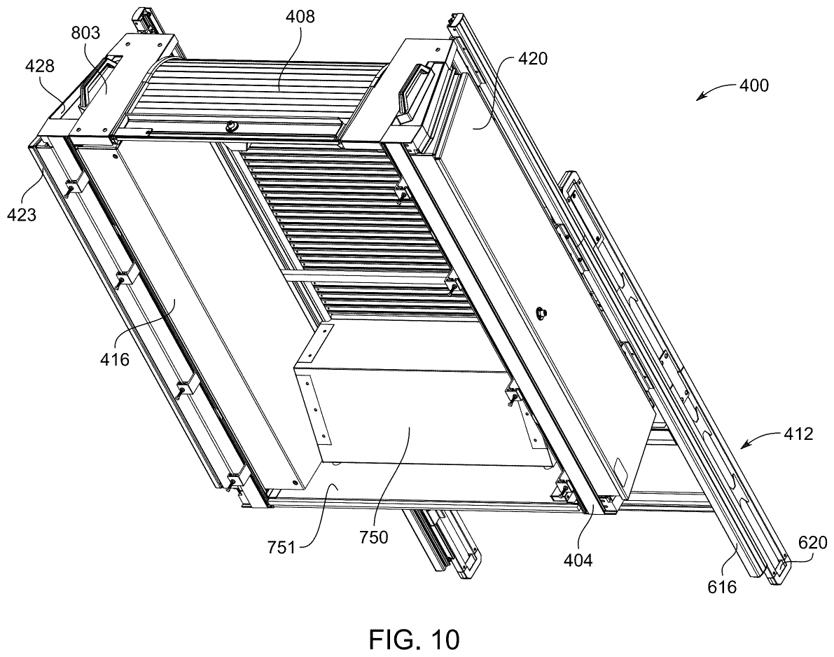

With reference to FIGS. 38d and 38e, a drain member 786 is positioned in each of the track members 738. The drain members 786 are mirror identical, so only one will be described. As shown, the drain member 786 is supported by the vertical portion 740 of the track member 738 and is in fluid communication with the flange 747. In the illustrated embodiment, the drain member 786 is at least partially positioned within the flange 747. The drain member 786 has an inlet 790 positioned in the flange 747 and an outlet 792 positioned outside of the flange 747. The drain member 786 directs water from the flange 747 to the inlet 790 and then to the outlet 792. The drain member 786 further includes a deflector 794 positioned between the inlet 790 and the outlet 792. The deflector 794 may include an opening so that water can travel between the inlet 790 and the outlet 792. The deflector 794 redirects water entering the truck cap assembly through the outlet 792 back toward the outlet 792 and thus prevents water from entering the track member 738 and the truck bed through the drain member 786. In the illustrated embodiment, the drain member 786 routes the water in the flange 747 to an opening 796 of the intermediate post 785, and the water exits out of the intermediate post 785 through another opening. In some examples, the drain member 786 may route the water from the flange 747 to an opening or channel in the frame 404, such that the water exits out of the frame 404. By routing the water through the intermediate post 785 or the frame 404, the water can directly drain to the outside of the truck cap assembly 400. In some embodiments, rear frame caps 803 are coupled between the posts 428 and the vertical portion 740 of the track members 738 (FIG. 10). The rear frame caps 803 provide support for the track members 738 and provide sealing and locking surfaces for the cover 742.

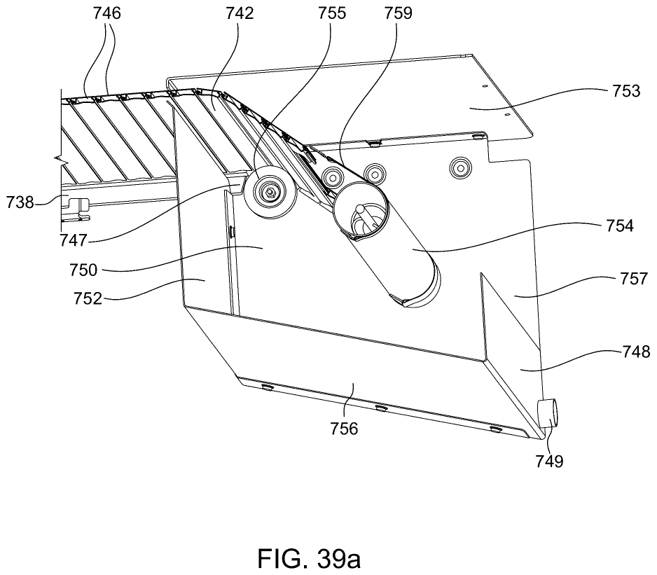

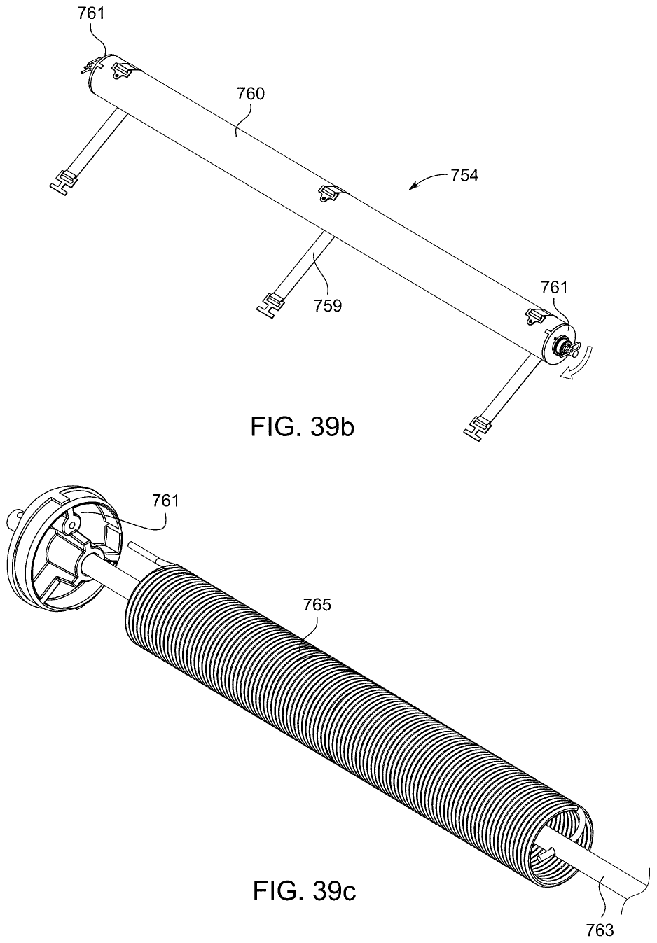

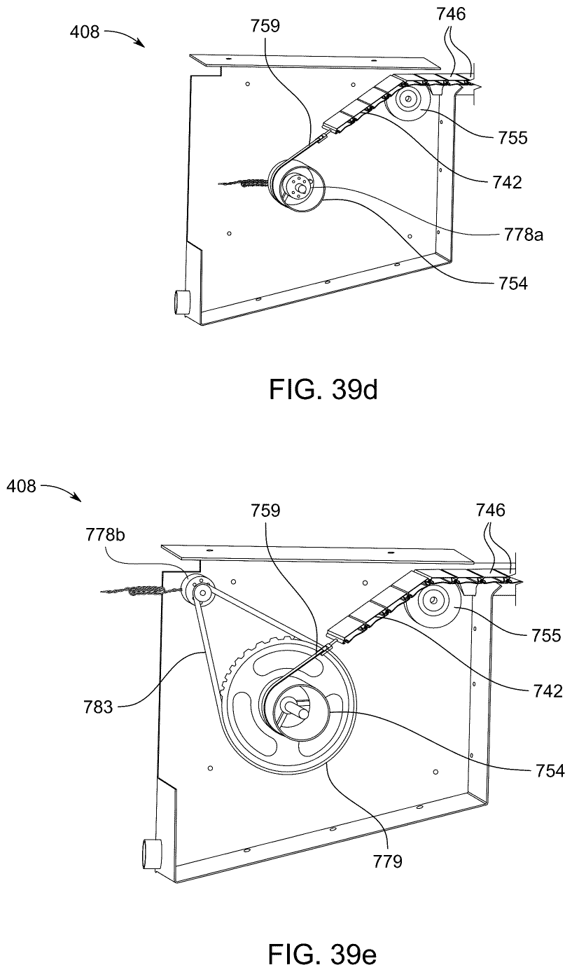

With reference to FIGS. 38a and 39a-c, the cover assembly 408 further includes a cover housing 750 supported by the frame 404 adjacent to the cab 203 (see FIG. 3). The cover housing 750 includes a rear wall 748, a front wall 752, a top wall 753, a bottom wall 756, and a pair of side walls 757. In the illustrated embodiment, the cover housing 750 is coupled to or otherwise positioned adjacent to a front panel 751 (FIG. 10) of the cover assembly 408, as shown. Specifically, the rear wall 748 is positioned adjacent the front panel 751. The top wall 753 and the side walls 757 are configured to be coupled to the frame 404. In the illustrated embodiment, the top wall 753 and the side walls 757 are coupled to the horizontal beams 432 via the intermediate beams 714. The flange 747 extends into the cover housing 750, such that water can exit the flange 747 and flow into the cover housing 750. The rear wall 748 includes an outlet 749 through which the water can exit the cover housing 750. The bottom wall 756 is inclined, such that the water exiting the flange 747 adjacent the front wall 752 flows down the bottom wall 756 toward the rear wall 748 and the outlet 749. The outlet 749 may also be configured to extend through the front panel 751 of the truck cap system 400, such that water is routed away to the exterior of the truck bed.

A roller 754 is positioned within the cover housing 750 and extends between the side walls 757. The roller 754 includes a body 760, end caps 761 on opposite ends of the body 760, a shaft 763 extending through the body 760 between the end caps 761, and a biasing member 765 (e.g., a spring) positioned within the body 760. The shaft 763 is coupled to each of the end caps 761. The spring 765 is coupled at one end to the shaft 763 and at the other end to one of the end caps 761. The body 760 is rotatable about the shaft 763 relative to the end caps 761.

The roller 754 is connected to the cover 742 via at least one strap or cable 759. As shown, the strap 759 extends from the body of the roller 754 to the forward-most panel 746 of the cover 742. The cover 742 is maintained under tension by guide wheels 755 on interior surfaces of the side walls 757 of the cover housing 750. In other words, the cover 742 is coupled to the roller 754, engages the guide wheels 755, and is received within the tracks 743 of the track members 738.

As the cover 742 moves along the track members 738, the cover 742 winds onto or unwinds from the roller 754. As the cover 742 moves from the closed position to the open position, the cover 742 winds onto the roller 754. As the cover 742 moves from the open position to the closed position, the cover 742 unwinds from the roller 754. The cover assembly 408 is operated manually by a user. In some examples, the cover 742 may include a handle 767 (FIG. 9) configured to be pulled by the user. The cover 742 is biased into the open position via the spring 765 of the roller 754. The user must pull or otherwise exert a force on the cover 742 at the rear-most panel 746 to overcome the bias of the spring and move the cover 742 to the closed position.

In another embodiment, the cover assembly 408 may be operated by a motor. In some examples, as shown in FIG. 39d, the cover assembly 408 may include an inline motor 778a directly coupled to the roller 754. The motor 778a is configured to drive the roller 754 in a first direction such that the cover 742 is wound onto the roller 754 and in a second direction such that the cover 742 is unwound from the roller 754. In some examples, as shown in FIG. 39e, the cover assembly 408 may include a motor 778b operatively coupled to the roller 754 via a gear 779 directly coupled to the roller 754 and a belt 783 extending between the motor 778b and the gear 779. The motor 778b, the gear 779, and the belt 783 are configured to drive the roller 754 in a first direction such that the cover 742 is wound onto the roller 754 and in a second direction such that the cover 742 is unwound from the roller 754.

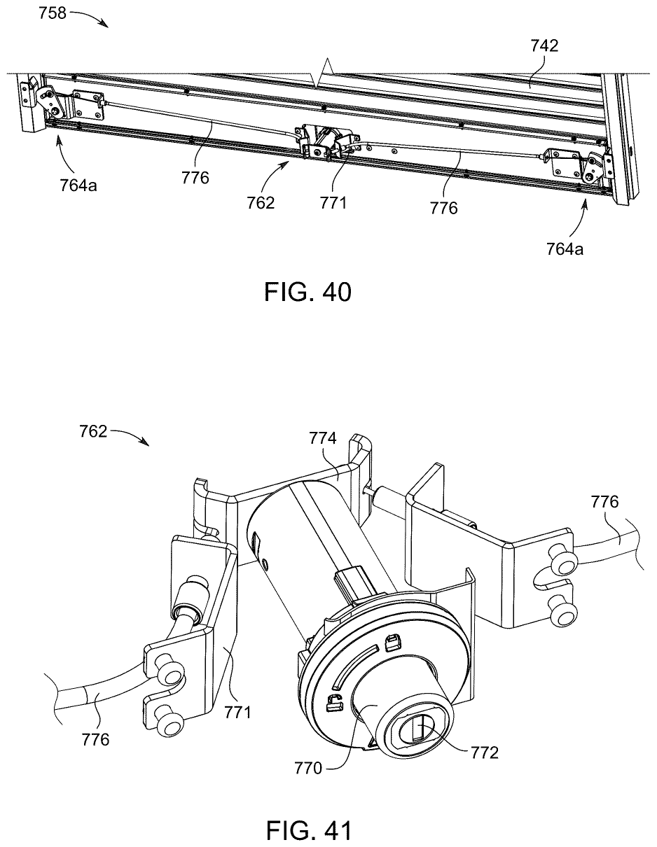

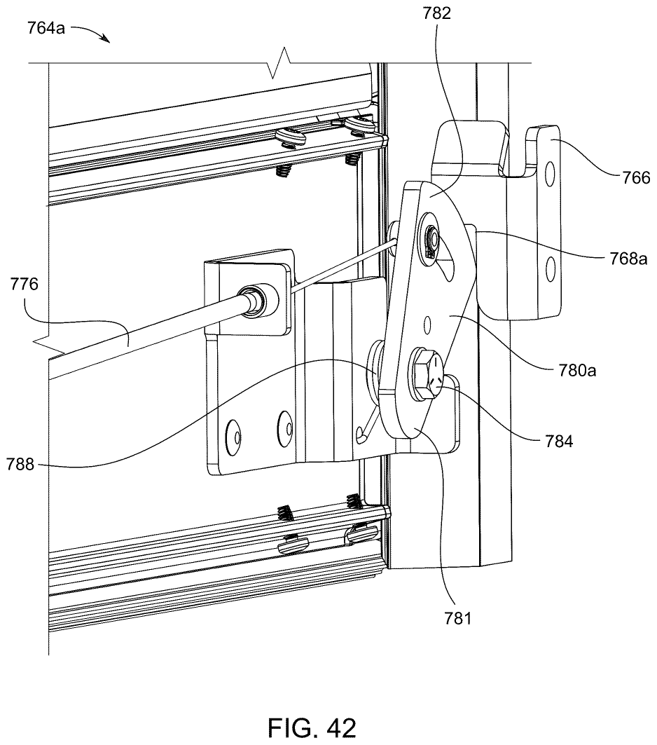

With reference to FIGS. 40-42, the cover assembly 408 includes a locking mechanism 758 configured to lock the cover 742 in the closed position. The locking mechanism 758 is coupled to the rear-most panel 746, as shown. The locking mechanism 758 includes a lock assembly 762 and a pair of latch assemblies 764a configured to latch and unlatch the cover 742 to the frame 404. The lock assembly 762 moves the latch assemblies 764a between a latched position and an unlatched position. The lock assembly 762 has a push button 770, a key lock 772 configured to selectively lock and unlock the push button 770, and a cable bracket 774 positioned at an end of the push button 770. The cable bracket 774 is coupled to a pair of opposing cables 776. The lock assembly 762 further includes guide brackets 771 coupled to the cover 742 that guide the opposing cables 776 toward the latch assemblies 764a.

The latch assemblies 764a are mirror identical. The latch assembly 764a includes a latching bracket 766 mounted to the frame 404 and a pivotable arm 780a mounted on the cover 742 and pivotable about a shaft 784. In some examples, the latching bracket 766 is mounted to the track members 738. The latching bracket 766 includes a notch 768a configured to receive a portion of the pivotable arm 780a. The pivotable arm 780a is biased via a spring 788 into the notch 768a of the latching bracket 766. The pivotable arm 780a has a triangular shape. The pivotable arm 780a is pivotably coupled to the shaft 784 at a first end 781 and is coupled to a respective one of the opposing cables 776 at a second end 782 opposite the first end 781. The pivotable arm 780a engages the latching bracket 766 at the second end 782.

To unlatch the cover 742, the user may push on the push button 770 so that the push button 770 presses the cable bracket 774 toward a first direction. As the cable bracket 774 moves in the first direction, the cable bracket 774 pulls the cables 776 inward towards the push button 770. When the cable 776 is pulled inward, the cable 776 in turn pulls on the second end of the pivotable arm 780a such that the pivotable arm 780a rotates out of engagement with the latching bracket 766. Once the pivotable arm 780a clears the latching bracket 766, the cover 742 is free to move relative to the frame 404.

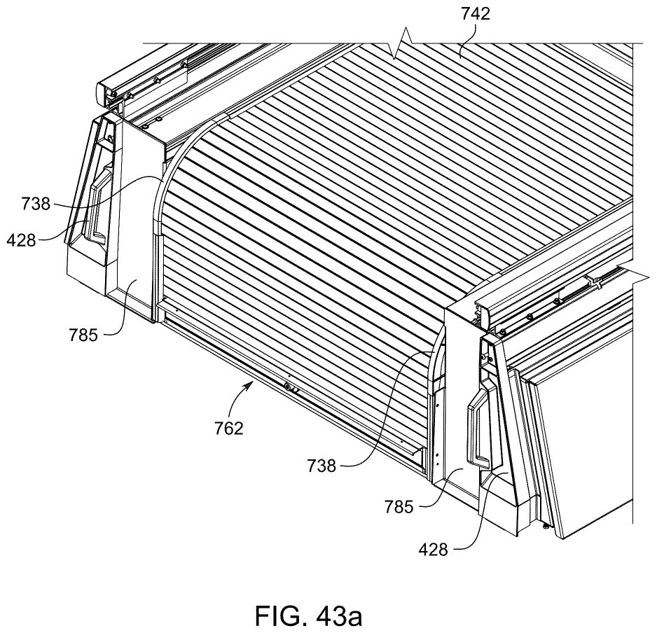

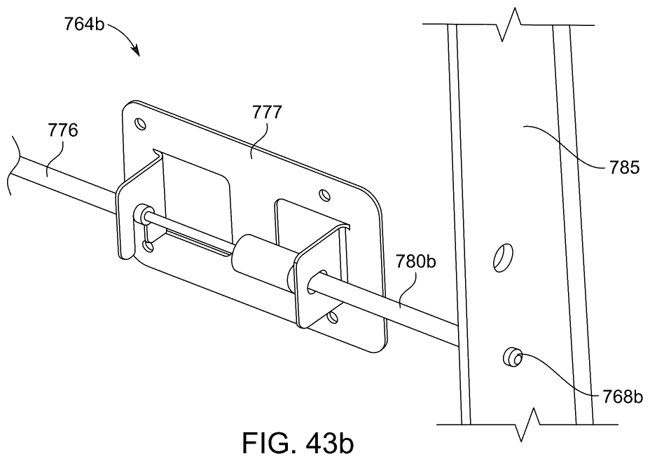

FIGS. 43a-b illustrate another example of a latch assembly 764b that may be part of the locking mechanism 758 and may be used as a pair of latch assemblies 764b with the lock assembly 762 and cables 776. A pair of intermediate posts 785 are each positioned between one of the track members 738 and one of the vertical posts 428. The latch assemblies 764b are mirror identical. Each latch assembly 764b includes an opening 768b positioned in one of the intermediate posts 785. In some examples, the openings 768b are positioned in the frame 404. In some examples, the openings 768b are positioned in the track members 738. One of the openings 768b is positioned in one of the intermediate posts 785, and the other opening 768b is positioned in an opposite intermediate post 785. Each latch assembly 764b includes an alignment bracket 777 mounted on the cover 742 and a pin 780b slidably mounted in the alignment bracket 777. The pins 780b are each coupled to a respective one of the cables 776. The pins 780b are each biased into the latched position and toward a respective one of the openings 768b. The pins 780b are slidable between the latched position, in which the pins 780b are positioned in the openings 768b, and the unlatched position, in which the pins 780b are removed from the openings 768b. To unlatch the cover 742, the user may push on the push button 770 so that the push button 770 presses the cable bracket 774 toward a first direction. As the cable bracket 774 moves in the first direction, the cable bracket 774 pulls the cables 776 inward. When the cables 776 are pulled inward, the cables 776 pull the pins 780b inward out of engagement with the openings 768b.

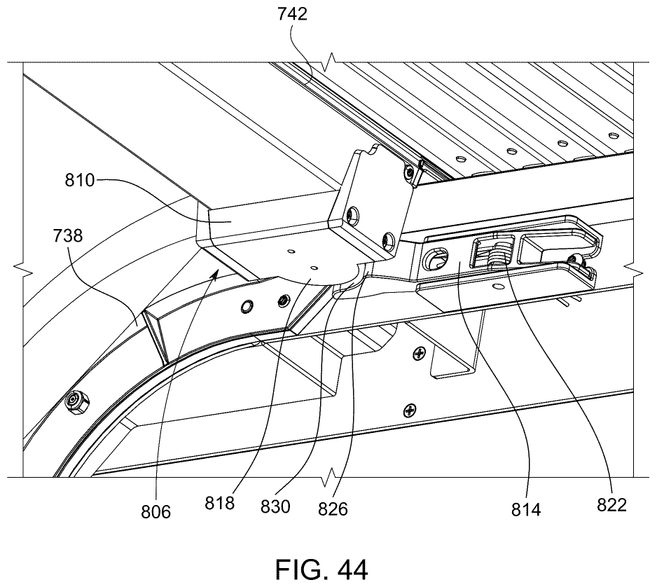

With reference to FIG. 44, the cover assembly 408 includes a stopping mechanism 806 on each track member 738. The stopping mechanisms 806 are aligned with each other on the track members 738 and are mirror identical. As such, only one stopping mechanism 806 is shown. The stopping mechanisms 806 are configured to hold the cover 742 in the intermediate position (FIG. 38a). In some examples, the cover assembly 408 may only include a stopping mechanism 806 on one of the track members 738. In the illustrated example, the stopping mechanisms 806 are positioned adjacent the curved portions of the track member 738. This placement of the stopping mechanism 806 permits rear access to the truck bed without requiring the user to hold the cover 742 in place or fully open the cover 742. The stopping mechanism 806, however, can be positioned at any point on the track member 738. In some examples, the cover assembly 408 may include a plurality of stopping mechanism pairs at different positions on the track members 738 between the open position and the closed position.

Each stopping mechanism 806 includes a bumper 810 coupled to the cover 742 and a flipper 814 coupled to the track member 738. The flipper 814 can also or alternatively be coupled to the frame 404. The bumper 810 includes a projection 818. The projection 818 is curved and, specifically, is semi-circular. The flipper 814 is pivotable and is biased away from the track member 738 and toward the bumper 810 via a spring 822 positioned at a front end of the flipper 814. The flipper 814 includes a catch 826 positioned between the front end and an opposite rear end. The flipper 814 is configured to engage the projection 818. The catch 826 projects toward the bumper 810. The flipper 814 includes an engagement surface 830 (e.g., a curved surface) on a rear end of the catch 826 (e.g., the front side of the catch 826) adjacent to the rear end. The engagement surface 830 is a concave curved surface. In other embodiments, the engagement surface 830 may have other shapes that are complementary to the shape of the projection 818.

During movement of the cover 742 along the track member 738, the bumper 810 travels with the cover and engages the flipper 814. When the projection 818 contacts the catch 826 and is seated in the engagement surface 830, the bias of the spring 822 enables the flipper 814 to resist further movement of the bumper 810, and, thus, the cover 742, in either direction along the track member 738. If the force applied to the cover 742 is below a threshold force sufficient to overcome the bias of the spring 822, the catch 826 prevents the projection 818 from passing and holds the cover 742 in a stopped position. When a user applies a force to the cover 742 that is equal to or greater than the threshold force, the projection 818 presses against the engagement surface 830 of the flipper 814 and causes the flipper 814 to pivot against the bias of the spring 822 and away from the cover 742. This pivoting movement allows the projection 818 to clear the catch 826 so that the cover 742 can move past the stopping mechanism 806. The stopping mechanism 806 thus provides a detent mechanism that allows the cover 742 to stop in the intermediate position, while allowing the cover 742 to be moved past the intermediate position if additional force is applied to the cover 742.

Referring back to FIG. 36, the cover assembly 408 may be removably mounted on or assembled onto the frame 404 by the user. In the provided embodiment, the cover assembly is coupled to the frame 404 via the intermediate beams 714. Specifically, the intermediate beams 714 are coupled to the horizontal beams 432 via fasteners, and the track members 738 are coupled to the intermediate beams 714 (e.g., the support portions 720 thereof) via fasteners and rivet nuts 802. In the illustrated embodiment, the track members 738 are positioned on and supported by the ledges 728 of the intermediate beams 714 when the track members 738 are coupled thereto. The cover housing 750, with the cover 742 and roller 754 therein, is also secured to the intermediate beams 714 (e.g., the support portions 720 thereof) via fasteners and rivet nuts 802. The ledges 728 hold the track members 738, and the cover assembly 408, in place while the user secures the track members 738 and the cover housing 750 to the intermediate beams 714 via the fasteners and rivet nuts 802. The cover 742 can then be guided from the cover housing 750 into the tracks 743 of the track members 738. In some examples, the intermediate beams 714 may not include ledges 728.

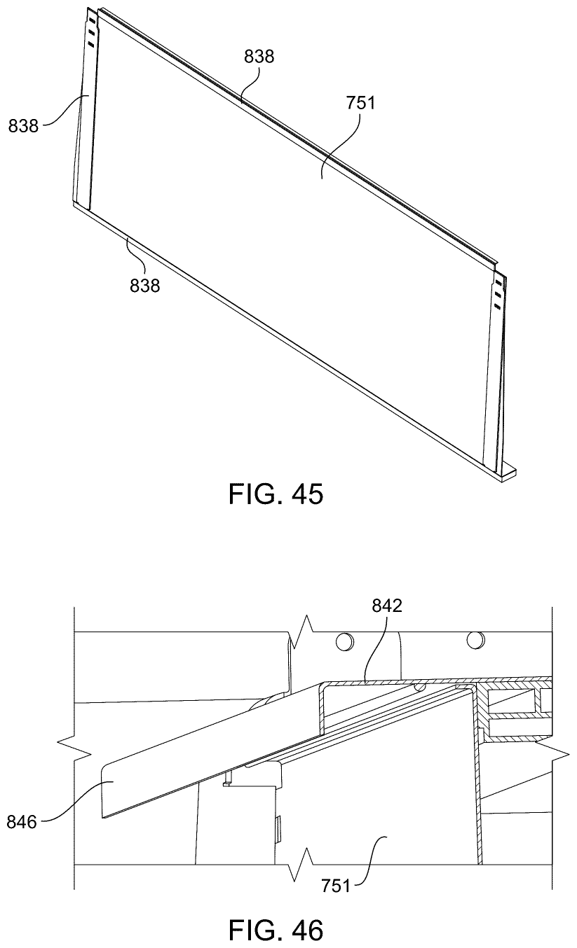

With reference to FIGS. 10, 11, 45, and 46, the front panel 751 of the truck cap system 400 may include seals 838 placed on a perimeter thereof to seal a front of the truck bed. The front panel 751 may be coupled to the vertical posts 428 of the frame 404 via fasteners. The seals 838 prevent water from getting under or behind the front panel 751. The frame 404 may further include a top panel 842. The top panel 842 may include a flange 846 extending over the front panel 751. The flange 846 may prevent water from entering the truck bed. The seals 838 may be compressed against the frame 404. The seals 838 may be rubber or foam. The frame 404 and the front panel 751 may be made of powdered aluminum.

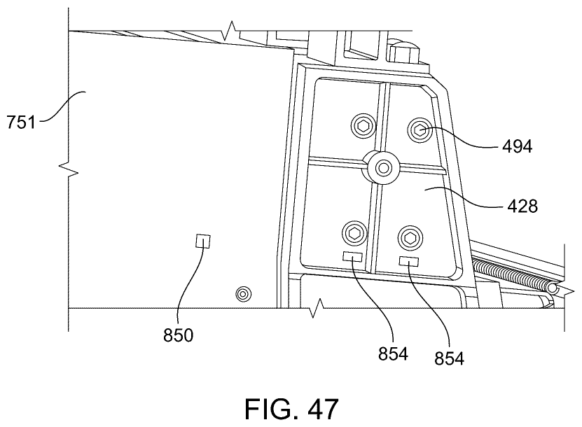

With reference to FIG. 47, the front panel 751 includes openings 850 adjacent the vertical posts 428. Water that enters the horizontal beams can flow out of the frame 404 via the openings 850 in the front panel 751. Further, the vertical posts 428 include openings 854 through which water can exit the frame 404. Specifically, the openings 854 are aligned with the horizontal beams such that water in the horizontal beams can exit through the vertical posts 428.

Referring back to FIGS. 9-12, the positioning of the cross-bars 436 of the frame 404, the selective positioning of the cover 742, and the slidable ladder rack assembly 412 cooperate to provide unobstructed access into the truck bed from the top end 425 and the rear end 422 of the frame 404 without removing the frame 404, the cover assembly 408, and the ladder rack assembly 412. The cross-bars 436 are positioned in only a forward longitudinal portion of the frame 404, as discussed above, leaving an open region along the remaining portion of the frame 404. Because the cover 742 is supported solely by the track members 738 positioned on opposing sides of the frame 404, vertical access to the truck bed is preserved across the open region. When the cover 742 is in the open position and the ladder rack 620 is positioned in the forward, or retracted position, the open region of the frame 404 permits large or tall items, such as pallets, to be placed into the truck bed without removal of the entire truck cap system 400, the frame 404, the cover assembly 408, or the ladder rack assembly 412. In other words, placement of the cover 742 in the open position and placement of the ladder rack 620 in the retracted position provides access to the open region of the frame.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

What is claimed is:

1. A truck cap system for a truck, the truck cap system comprising:
a frame configured to be removably coupled to the truck, the frame including
a pair of foundation rails configured to be removably coupled to the truck,
a plurality of vertical posts extending from the pair of foundation rails, and
a pair of frame beams spaced from the foundation rails and coupled to the plurality of vertical posts;
a cover assembly removably coupled to the frame, the cover assembly including a cover moveable between an open position and a closed position; and
at least one of a storage module assembly or a side door assembly removably couplable to the frame.

2. The truck cap system of claim 1, wherein the plurality of vertical posts is removably coupled to the foundation rails.

3. The truck cap system of claim 1, wherein the at least one of the storage module assembly or the side door assembly has a base frame configured to be coupled to one of the foundation rails and a door panel pivotably coupled to the base frame.

4. The truck cap system of claim 3, wherein the base frame includes an opening and a lip extending around a perimeter of the opening, and wherein the door panel overlaps the lip and selectively closes the opening.

5. The truck cap system of claim 1, further comprising a front panel positioned on the frame and configured to be positioned adjacent to a cab of the truck, wherein at least one of the front panel or the vertical posts has an opening configured to drain water from the frame.

6. The truck cap system of claim 1, further comprising a sliding ladder rack assembly removably coupled to the frame.

7. The truck cap system of claim 1, wherein the cover assembly is mounted to the frame via a plurality of intermediate beams interlocking with the frame.

8. The truck cap system of claim 1, wherein the frame includes a front end, a rear end, a length measured between the front end and the rear end, and at least one cross-bar extending between the pair of frame beams, the frame defining a central point along the length that is half-way between the front end and the rear end, and wherein the frame is devoid of a cross-bar in a region measured between the rear end and the central point.

9. A truck cap system for a truck, the truck cap system comprising:
a frame configured to be coupled to the truck, the frame including
a plurality of posts, and
a frame beam coupled to the plurality of posts, the frame beam defining one of a recess or a ridge;
an intermediate beam removably coupled to the frame beam of the frame, the intermediate beam including
a support portion, and
an interlocking portion defining the other of the recess or the ridge,
wherein the ridge is received in the recess to interlock the frame beam and the intermediate beam; and
a cover assembly removably coupled to the support portion of the intermediate beam such that the cover assembly is removably mounted on the frame via the intermediate beam.

10. The truck cap system of claim 9, further comprising a seal positioned between the frame beam and the interlocking portion of the intermediate beam.

11. The truck cap system of claim 9, wherein the frame beam includes the recess, and the intermediate beam includes the ridge, and wherein the intermediate beam is supported by the frame beam in the recess.

12. The truck cap system of claim 11, wherein the recess is a first recess and the ridge is a first ridge, and wherein the frame beam includes a second ridge, and the intermediate beam includes a second recess that receives the second ridge to interlock the frame beam and the intermediate beam.

13. The truck cap system of claim 9, wherein the cover assembly includes a cover slidably supported by a pair of track members, and wherein each of the pair of track members is coupled to the support portion of a respective intermediate beam.

14. The truck cap system of claim 13, wherein the pair of track members each include an elongated flange configured to guide water away from a truck bed.

15. A truck cap system for a truck, the truck cap system comprising:
a frame configured to be coupled to the truck, the frame including
a plurality of posts, and
a pair of frame beams coupled to the plurality of posts; and
a slidable ladder rack assembly removably coupled to the frame, the slidable ladder rack assembly including
a pair of track members each corresponding to and removably mounted on a respective one of the frame beams, and
a rack slidably supported on the pair of track members.

16. The truck cap system of claim 15, wherein the rack includes a plurality of rollers, and the pair of frame beams each include a channel receiving at least one roller of the plurality of rollers.

17. The truck cap system of claim 15, further comprising a locking mechanism configured to selectively lock the rack in at least one of an extended position or a retracted position, wherein a track member includes an opening, and the locking mechanism is engageable with the opening.

18. The truck cap system of claim 17, wherein the rack includes a plurality of rollers, and the pair of frame beams each include a channel receiving at least one roller of the plurality of rollers, and wherein the channel of at least one of the pair of frame beams includes the opening.

19. The truck cap system of claim 15, further comprising a cover assembly removably coupled to the frame, the cover assembly including a cover slidable between an open position and a closed position.

20. The truck cap system of claim 19, wherein placement of the cover in the open position and placement of the rack in a retracted position provides an open region in the frame.
